(19) United States
(12) Patent Application Publication
(10) Pub. No.: US 2024/0232589 A9
(43) Pub. Date: Jul. 11, 2024

(54) Automated, Constraints-Dependent Machine Learning Model Thresholding Mechanisms

(71) Applicant: Google LLC, Mountain View, CA (US)

(72) Inventors: Madhav Datt, Mountain View, CA (US); Surabhi Choudhary, Chennai (IN); Nikhil Shirish Ketkar, Bengaluru (IN)

(21) Appl. No.: 18/079,486

(22) Filed: Dec. 12, 2022

(30) Foreign Application Priority Data
Oct. 20, 2022 (IN) 202221060034

(51) Int. Cl. G06N 3/048; G06N 3/08

(52) U.S. Cl. CPC G06N 3/048; G06N 3/08

(57) ABSTRACT

Provided are computing systems, methods, and platforms for a discrete-valued output classification. The operations can include obtaining a candidate threshold value for a first slice in a plurality of data slices. Additionally, the operations can include calculating, using a candidate machine-learned model and the candidate threshold value, a first performance value associated with a first risk tolerance value. Moreover, the operations can include determining, based on the first performance value, that a safeguard criterion for the first slice has not been satisfied. In response to the determination that the safeguard criterion for the first slice has not been satisfied, the operations can include performing a tradeoff logic operation to determine the final threshold value. Subsequently, the operations can include determining, using the candidate machine-learned model, whether input data is authentic based on the final threshold value.

### FIELD

The present disclosure relates generally to machine learning. More particularly, the present disclosure relates to computing systems, methods, and platforms that automatically determines a threshold for classifying an input using constraints-dependent machine learning models to generate a discrete-valued (e.g., binary) output classification.

### BACKGROUND

Machine learning is a field of computer science that includes the building and training (e.g., via application of one or more learning algorithms) of analytical models that are capable of making useful predictions or inferences on the basis of input data. Machine learning is based on the idea that systems can learn from data, identify patterns, and make decisions with minimal human intervention.

Various machine learning libraries exist which assist software developers in generating and deploying machine learning models. In particular, in computer science, a library is a collection of non-volatile resources used by computer programs, often for software development. These may include configuration data, documentation, help data, message templates, pre-written code and subroutines, classes, values, or type specifications.

A software developer or other user or individual can interact with a software library to build and deploy a machine learning pipeline. A machine learning pipeline can include computer-readable code that automates the workflow it takes to produce and/or deploy a machine learning model. Machine learning pipelines can include multiple sequential steps that do everything from data extraction and preprocessing to model training and deployment.

However, building and/or deploying a machine learning pipeline can be a challenging and time-consuming task. In particular, while certain existing machine learning libraries or other tools provide powerful components that span the entire machine learning workflow, these resources are often overly complex and may be accessible only to individuals or teams with a high level of infrastructure sophistication and engineering resources to invest into data wrangling, pipeline configuration & architecture, and modeling decisions.

While for certain sophisticated users this level of complexity may be workable, a large number of software developers or other users do not have the level of expertise to easily use such complicated resources. Further, even for sophisticated users, designing, training, and deploying a machine learning model with an associated deployment pipeline can require a significant amount of time, such as weeks to months. Therefore, improved systems which facilitate the development of machine learning models are desired.

### SUMMARY

Aspects and advantages of embodiments of the present disclosure will be set forth in part in the following description, or can be learned from the description, or can be learned through practice of the embodiments.

According to an example embodiment, a computer-implemented method is described. The method can include obtaining a candidate threshold value for a first slice in a plurality of data slices, the candidate threshold value being utilized by a candidate machine-learned model for a discrete-valued output classification. Additionally, the method can include calculating, using the candidate machine-learned model and the candidate threshold value, a first performance value associated with a first risk tolerance value. Moreover, the method can include determining, based on the first performance value, that a safeguard criterion for the first slice has not been satisfied. In response to the determination that the safeguard criterion for the first slice has not been satisfied, the method can include determining a final threshold value for the first slice, wherein determining the final threshold value comprises performing a tradeoff logic operation to determine the final threshold value. Subsequently, the method can include determining, using the candidate machine-learned model, whether input data is authentic based on the final threshold value.

In some instances, the method can further include receiving the input data, the input data being associated with an update to an object in a mapping application. Additionally, the method can include generating signals based on the input data and inputting the signals into the candidate machine-learned model to generate a probability score. The method can include determining that the input data is authentic when the probability score exceeds the candidate threshold value, updating a map database associated with the mapping application based on the input data when the input data is determined to be authentic.

In some instances, the method can further include publishing, based on the probability score and the final threshold value, the input data on the mapping application.

In some instances, the first performance value can be a good pass-through rate (GPTR), and the first risk tolerance value can be a live abuse rate (LAR).

In some instances, the tradeoff logic operations can include increasing the first risk tolerance value by a step value to obtain a second risk tolerance value. Additionally, the tradeoff logic operation can include calculating, using the candidate machine-learned model and the candidate threshold value, a second performance value associated with the second risk tolerance value. Moreover, the tradeoff logic operation can include determining, based on the second performance value, that the safeguard criterion for the first slice has been satisfied. In response to the determination that the safeguard criterion for the first slice has been satisfied, the tradeoff logic operation can include selecting the final threshold value to be the candidate threshold value. The first performance value can increase when the first risk tolerance value increases, and wherein the second performance value is larger than the first performance value.

In some instances, the tradeoff logic operations can include increasing the first risk tolerance value by a step value to obtain a second risk tolerance value. Additionally, the operations can include calculating, using the candidate machine-learned model and the candidate threshold value, a second performance value associated with the second risk tolerance value. Moreover, the operations can include determining, based on the second performance value, that the safeguard criterion for the first slice has not been satisfied. In response to the determination that the safeguard criterion for the first slice has not been satisfied, the operations can further include increasing the second risk tolerance value by the step value to obtain a third risk tolerance value. Furthermore, the operations can include calculating, using the candidate machine-learned model and the candidate threshold value, a third performance value associated with the third risk tolerance value. Subsequently, the operations can include determining, based on the third performance value, that the safeguard criterion for the first slice has been satisfied. In response to the determination that the safeguard criterion for the first slice has been satisfied, the operations can include selecting the final threshold value to be the candidate threshold value.

In some instances, the tradeoff logic operations can include increasing the first risk tolerance value by a step value to obtain a second risk tolerance value. Additionally, the operations can include calculating, using the candidate machine-learned model and the candidate threshold value, a second performance value associated with the second risk tolerance value. Moreover, the operations can include determining, based on the second performance value, that the safeguard criterion for the first slice has not been satisfied and that the second risk tolerance value is at an upper bound limit. In response to the determination that the safeguard criterion for the first slice has not been satisfied and the second risk tolerance value is at the upper bound limit, the operations can further include selecting the final threshold value to be a fallback threshold value.

In some instances, the tradeoff logic operations can include calculating, using a baseline machine-learned model and the candidate threshold value, a baseline performance value associated with the first risk tolerance value, the baseline machine-learned model being currently utilized by a mapping application to determine whether the input data is authentic. The operations can include selecting the final threshold value to be the final threshold value when the first performance value is greater than the baseline performance value. In some instances, the final threshold value can be the candidate threshold value when the first performance value is greater than the baseline performance value by at least a certain percentage (e.g., 5%, 10%).

In some instances, the tradeoff logic operations can include calculating, using a production machine-learned model and the candidate threshold value, a production performance value associated with the first risk tolerance value. The baseline (e.g., production) machine-learned model can be currently utilized by a mapping application to determine whether the input data is authentic. Additionally, the operations can include selecting the final threshold value to be a fallback threshold value when the first performance value is less than the production performance value.

In some instances, the discrete-valued output classification can be a binary classification.

In some instances, the safeguard criterion for the first slice has not been satisfied when the first performance value is below a lower limit threshold associated with a performance metric.

In some instances, the method can further include determining, based on the final threshold value, a second candidate threshold value for a second slice in a plurality of data slices. Additionally, the method can include transmitting the input data for human review based on the second candidate threshold value. Moreover, the method can include determining, based on the final threshold value and the second candidate threshold value, a third candidate threshold value for a third slice in a plurality of data slices. The method can further include determining, using the candidate machine-learned model, to not publish the input data based on the third candidate threshold value. Subsequently, the method can include determining, based on the final threshold value, the second candidate threshold value, and the third candidate threshold value, a fourth candidate threshold value for a fourth slice in a plurality of data slices. The method can further include determining, using the candidate machine-learned model, to ban a user associated with the input data based on the third candidate threshold value.

According to another example embodiment, a computing system is described. The computer system can include one or more processors and one or more non-transitory computer-readable media that collectively store: a candidate machine-learned model, and instructions that, when executed by the one or more processors, cause the computing system to perform operations. The candidate machine-learned model can be configured to generate a final threshold value for a first slice in a plurality of data slices. The operations can include obtaining a candidate threshold value for the first slice, the candidate threshold value being utilized by the candidate machine-learned model for a discrete-valued output classification. Additionally, the operations can include calculating, using the candidate machine-learned model and the candidate threshold value, a first performance value associated with a first risk tolerance value. Moreover, the operations can include determining, based on the first performance value, that a safeguard criterion for the first slice has not been satisfied. In response to the determination that the safeguard criterion for the first slice has not been satisfied, the operations can include performing a tradeoff logic operation to determine a final threshold value for the first slice. Furthermore, the operations can include determining, using the candidate machine-learned model, whether input data is authentic based on the final threshold value.

In some instances, the operations can further include receiving the input data, the input data being associated with an update to an object in a mapping application. Additionally, the operations can include generating signals based on the input data and inputting the signals into the candidate machine-learned model to generate a probability score. Moreover, the operations can include determining that the input data is authentic when the probability score exceeds the candidate threshold value. Subsequently, the operations can include updating a map database associated with the mapping application based on the input data when the input data is determined to be authentic. In some instances, the operations further include publishing, based on the probability score and the final threshold value, the input data on the mapping application.

According to another example embodiment, one or more non-transitory computer-readable media is described. The media can collectively store a candidate machine-learned model, wherein the candidate machine-learned model has been learned by performance of operations. The operations can include obtaining a candidate threshold value for a first slice in a plurality of data slices, the candidate threshold value being utilized by the candidate machine-learned model for a discrete-valued output classification. Additionally, the operations can include calculating, using the candidate machine-learned model and the candidate threshold value, a first performance value associated with a first risk tolerance value. Moreover, the operations can include determining, based on the first performance value, that a safeguard criterion for the first slice has not been satisfied. In response to the determination that the safeguard criterion for the first slice has not been satisfied, determining a final threshold value for the first slice, wherein determining the final threshold value includes performing a tradeoff logic operation to determine the final threshold value. Furthermore, the operations can include determining, using the candidate machine-learned model, whether input data is authentic based on the final threshold value.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of implementations directed to one of ordinary skill in the art is set forth in the specification, which makes reference to the appended figures, in which:

FIG. 1 illustrates a block diagram of an example system for determining whether input data on a mapping application are valid according to example implementations of the present disclosure.

FIG. 2 depicts a flow chart diagram for determining a final threshold value according to example implementations of the present disclosure.

FIG. 3 depicts a block diagram of an example origination machine learning pipeline according to example implementations of the present disclosure.

FIG. 4 depicts a block diagram of an example origination machine learning pipeline according to example implementations of the present disclosure.

FIG. 5 depicts a block diagram of an example deployment machine learning pipeline according to example implementations of the present disclosure.

FIG. 6 depicts a flow chart diagram of an example method to perform according to example embodiments of the present disclosure.

FIG. 7A depicts a block diagram of an example computing system according to example implementations of the present disclosure.

FIG. 7B depicts a block diagram of an example computing device according to example implementations of the present disclosure.

FIG. 7C depicts a block diagram of an example computing device according to example implementations of the present disclosure.

Reference numerals that are repeated across plural figures are intended to identify the same features in various implementations.

### DETAILED DESCRIPTION

### Overview

Generally, the present disclosure is directed to computing systems, methods, and platforms that trains a machine learning model to classify an input by applying a threshold to generate a binary output classification. The determination of the threshold can be based on safety guardrails and metrics tradeoffs. The process of determining a threshold for a data slice can be part of the training process of the machine learning model. In some instances, a machine learning model can generate an output that ranges across a span of values (e.g., 0.0 to 1.0), and the output can be converted to a discrete-valued (e.g., binary) output based on the threshold value. The discrete-valued output can then be used to perform analysis downstream or perform an action (e.g., to classify a map update as fraudulent or non-fraudulent). For example, based on the binary classification, the system can determine whether to update a map database.

Machine learning developers desire an improvement in the performance of an existing machine learning model by enabling ease of use by automating the threshold-setting process. The process of setting such thresholds can be part of the model training process. However, in many applications the threshold-setting process depends upon a variety of factors, making it difficult to perform in an automated fashion. Instead, many applications include the use of manual threshold-setting in order to leverage human intuition to set thresholds in view of a range of different factors. Such factors can include the cost (e.g., in time, computational resources, quality control resources) of increasing or decreasing the value of the threshold. Additionally, optimizing the threshold value can result in a decrease in the number of incidents requiring manual review. Moreover, optimizing the threshold value can improve the user experience by decreasing the number of user interactions that are unnecessarily blocked.

The determination of the threshold can be further optimized based on dependencies and correlations of different data slices of a plurality of inputs. In some instances, a first data slice can be dependent and/or correlated to a second data slice. As a result, the machine learning model can be trained based on constraints-dependent data representing all of the data slices. For example, each data slice can represent a respective non-overlapping set of users or other non-overlapping subset of past or future inputs for which the factors pertinent to threshold setting differ. For example, the different slices could represent different classes of users that have different user attributes (e.g., trusted users vs. non-trusted users). Accordingly, it can be advantageous to train a machine learning model based on inputs from such different slices, and to perform inference for inputs corresponding to such different slices based on slice-dependent thresholds.

The embodiments described herein provide systems and methods for generating slice-specific thresholds for the outputs of a trained machine learning model based on a set of constraints and metrics that may differ between the slices. The slice-specific metrics and slice-specific constraints can be dependent on the attributes of the slice. Accordingly, it can also be beneficial to perform calibration of the model output on a per-slice basis. Such per-slice calibration could be used in the context of per-slice threshold determination in order to further improve the final model output determination by further improving the determined slice-specific thresholds.

The embodiments described herein provide a variety of technical benefits, including reducing the memory requirement or other computational costs of calibrating the output of a machine learning model and determining output threshold values for such a machine learning model. These benefits can be realized in an online pipeline-style environment (e.g., TensorFlow or TFX) where inputs are computed individually, such that determining discrete-valued output (e.g., binary classification) for each input can be expensive with respect to memory or other computational costs.

As used herein, a “constraint” is a set of one or more requirements with respect to which a particular threshold value may ‘pass’ or ‘fail’ when applied to a set of inputs of a particular slice. For example, a “constraint” could be a requirement that the live abuse rate (LAR) be less than 2% of the published content on the mapping application. Thus, evaluating a “constraint” with respect to a particular slice of input data and a particular threshold value may include evaluating a number of separate functions and then determining whether the particular threshold value satisfies all of the constraints or some other specified number or fraction of the constraints.

As used herein, a “metric” is a function that describes a quality of the classification of a set of inputs of a slice by thresholding the output of a machine learning model. For example, a marginal precision of classification of inputs by applying the inputs to a machine learning model and then thresholding the outputs using a particular threshold value could be determined and used as a metric. Such a metric may be discrete-valued (e.g., could have a discrete set of outputs spanning a range of values) or continuous-valued.

The proposed system reduces time and effort for entry-level users of a machine learning model who are not familiar with the internal systems or infrastructure of the machine learning model. Software developers who are not familiar with the machine learning model can use the proposed system to experiment with a new signal for the machine learning model without interacting directly with the internal systems or infrastructure of the machine learning model.

The techniques described herein reduce the need for the manual intervention by a software developer or other user that is necessary in order to operate the proposed system. For example, in some implementations, the only inputs required from a software developer are to provide the initial inputs of the training dataset and analyze the final results produced by the system. Additionally, the system can be packaged into a custom TensorFlow Extended (TFX) component that can be added to a TFX machine learning pipeline. For example, the custom TFX component can use various relevant data slices from other TFX components as input and generate and export a trained candidate machine learning model. The output produced by the custom TFX component can then be used by downstream components of the TFX machine learning pipeline.

With reference now to the Figures, example implementations of the present disclosure will be discussed in greater detail.

In conventional systems, many applications utilize manual threshold setting in order to leverage human intuition to set thresholds in view of a range of different factors. However, as noted before, such manual threshold setting can be expensive, prone to error, and slow.

Additionally, the automatic thresholding techniques described herein support dependent thresholds, perform tradeoff logic operations, and consider the slice sample size when determining the final threshold value. In contrast, conventional automatic threshold mechanisms do not support dependent thresholds, do not perform tradeoff logic operations, and do not consider the slice sample size.

According to some embodiments, the system supports dependent thresholds. For example, the pend budget can help in further reducing the risk tolerance (e.g., LAR) and increase performance (e.g., GPTR). For utilizing this pend budget efficiently, the system utilizes an additional threshold “pend threshold.” The pend threshold can be dependent on the “deny threshold.” With this novel design, the system is able to return the pend threshold and the deny threshold for any slice.

According to some embodiments, the system can perform tradeoff logic operations. In conventional designs, the system first checks the performance metric and then the optimization metric. Conventional designs do not determine the final threshold value based on a tradeoff logic operation. For example, when the system does not find any candidate threshold value at LAR being 1.5% for a specific slice, then the conventional thresholding mechanism will not return any threshold for that slice. However, it could be possible to have a better performance (e.g., better GPTR) at LAR being 2%, so by performing a tradeoff logic operation, the system is able to find a valid candidate threshold value because the system is able to process trade offs rather than hard set constraints.

According to some embodiments, the system can consider the slice sample size when determining the final threshold value. In some instances, before calculating the final threshold values for the data slices, the system can check whether the slice sample size is greater than a large enough for us to have confidence in the threshold. We will have one fallback slice specified in config in case of low threshold confidence.

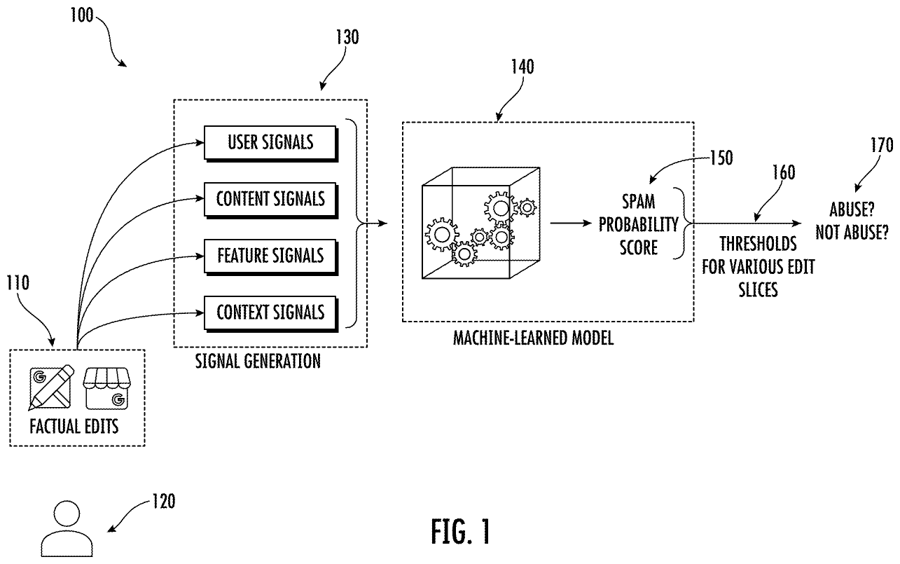

FIG. 1 illustrates an example system 100 for determining whether input data (e.g., user input, user contributions, user suggested edits, modifications) on a mapping application are valid. In some instances, the system 100 can receive input data 110 (e.g., factual edit) from a user 120. For example, a first user 120 can edit an attribute (e.g., location, hour of operations, name, phone number) associated with an object (e.g., restaurant hospital) of the mapping application. The system 100 can generate signals 130 based on the attributes associated with the object and attributes associated with the user. The signals 130 can include user signals, content signals, feature signals, context signals. The signals 130 are inputted into a machined-learned model 140 to determine a spam probability score 150. Subsequently, the system 100 can make a binary classification decision 170 on whether the input data are either spam (e.g., abuse) or valid (e.g., not abuse) based on a threshold value 160 and the probability score 150 (e.g., spam probability score). If the machine-learned model 140 determines that the input data is valid, then the system 100 can publish the edit on the mapping application. In some instances, once the input data is published, any user of the mapping application can view the input data. Alternatively, if the model determines that the input data is spam, then the input data does not get published.

The model can select a first threshold value 160 from a plurality of threshold values based on the signals 130 and the data slice associated with the input data 110. The different slices in the plurality of slices can represent different types (e.g., hospital location, hours of operations for a restaurant, phone number for a store) of input data. Each slice in the plurality of slices can be associated with a specific threshold value 160. The thresholds can represent different levels of risk, different levels of quality, and so on.

For example, a first user 120 has been contributing input data 110 that is constantly valid for an extended period of time (e.g., 10 years) will be associated with a data slice having a higher chance of providing valid input data in comparison to a second user that has just created a new account. In another example, input data 110 received from the first user 120 that resides in the same city as the business being edited will be analyzed using a data slice that has a higher probability of having a valid input in comparison with input data 110 received from a second user that does not reside or travel to the city associated with the business being edited. In these examples, the input data 110 received from the first user 120 has a lower likelihood of being spam in comparison to the input data received from the second user 120. As a result, the threshold value for the different users (e.g., first user 120, second user) can be different based on the user attributes. The threshold for each data slice can be determined by the system based on different levels of risk tolerance, risk acceptability, as well as harm that can be caused if spam gets published.

The threshold can be determined based on different levels of risk tolerance, and different levels of harm that can occur if the input data is published. The different levels of risk tolerance and harm can be based on the type of entity associated with the input data. For example, when the input data is changing the operating hours of a restaurant on a mapping is spam, the harm caused by publishing the incorrect operating hours is less than the harm associated with publishing an incorrect address for a hospital. Based on the level of harm associated with publishing incorrect information, the different levels of risk appetite and risk tolerance can be determined by the system. Thus, each data slice can be treated differently by the system, and each data slice can have different threshold values for the output classification. For example, for input data 110 associated with a first data slice (e.g., associated with a low likelihood of being spam), the system can publish the input data 110 when the probability score 150 is above 0.50, while for input data 110 associated with a second data slice (e.g., associated with a high likelihood of being spam), the system can publish the input data 110 when the probability score 150 for one slice is above 0.99.

The different data slices can be associated with different domains (e.g., industry) and each data slice can have a threshold value based on the risk tolerance associated with the domain. With conventional systems, determining an accurate threshold value can be a difficult problem to solve due to the amount of data that has to be measured and also can require human judgment to modify the threshold value based on human experience. For example, for every threshold value determination, the threshold value is determined based on a specific point on a precision-recall curve. The precision-recall curve shows the tradeoff between precision and recall for different thresholds. A high area under the curve represents both high recall and high precision, where high precision relates to a low false positive rate, and high recall relates to a low false negative rate. The determination of the correct range on the precision-recall curve is typically not automated in conventional systems and requires an analyst to use their domain expertise and human judgment to determine the specific point on the precision-recall curve. In contrast, the techniques described herein enable for the automatic determination of threshold value by automatically determining the optimal range on the precision-recall curve for a specific data slice.

The techniques described herein improve automatic thresholding mechanisms by enabling a determination of a threshold value in a wide variety of domains. For example, prior automatic thresholding mechanisms cannot have worked properly in domains requiring a low false positive rate, such as a fraud defense domain (e.g., mapping application). As a result, prior systems required human input in order to determine the correct range on the precision-recall curve in order to calculate a valid threshold value.

The techniques described herein support dependent thresholds based on a plurality of different scenarios. The input data can be associated with different slices, each slice that has separate threshold values. In some instances, these threshold values may not be independent and can depend on the other threshold values. For example, it may be that across the three different slices of data, the system can accept a precision rate that is greater than 95% total, but each individual slice of data may have a precision that is lower than 95%. In another example, there may be multiple thresholds on the same slice of data when performing a multi-class classification. In a multi-class classification, there can be a first threshold value for publishing the input data, a second threshold value for sending the input data for human evaluation, a third threshold value for not publishing the input data, and a fourth threshold value for restricting (e.g., banning) a user account that provided the input data.

In some embodiments, the system can automatically perform tradeoff logic operations. In conventional systems, tradeoff logic operations can be made based on human judgment because in the past it may have been too complicated for a machine-learned algorithm to evaluate the different tradeoffs and capture the human-like element of judgment. Additionally, conventional systems do not consider the confidence level associated with a threshold. For example, assuming that a threshold is determined for a small data slice (e.g., five data points), but this threshold may not provide accurate predictions (e.g., does not generalize well) when applied to real datasets. If the threshold does not generalize well, it can mean that the system has a low confidence in the threshold. As a result, a threshold associated with a low confidence, may not provide accurate predictions with datasets that have high variance.

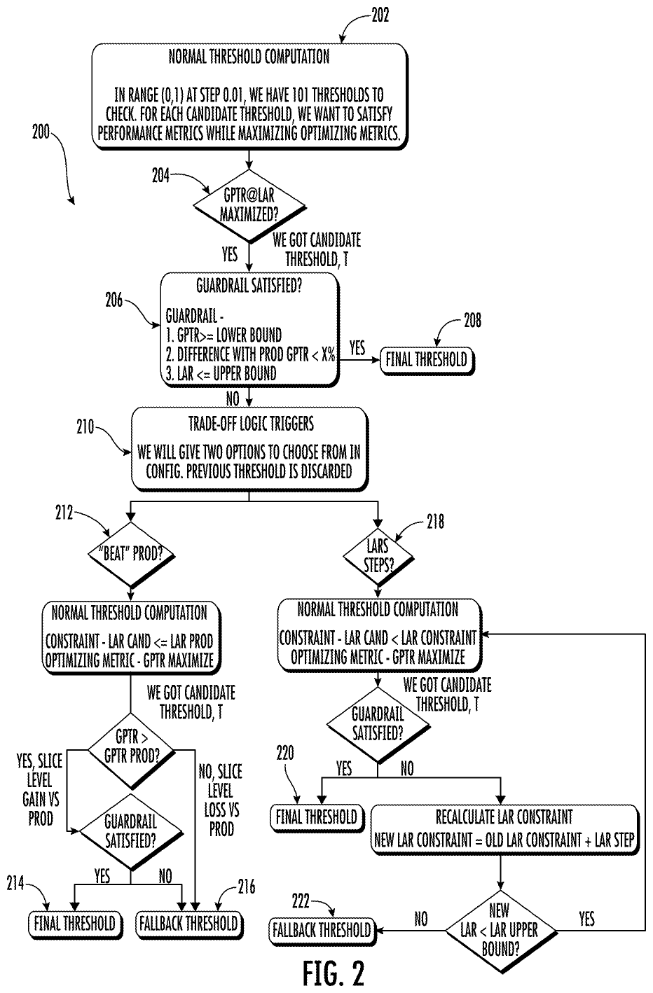

FIG. 2 depicts a flow diagram 200 for determining a final threshold value according to example implementations of the present disclosure. At operation 202, the system can obtain a candidate threshold value from a plurality of candidate threshold value. For example, in the range (0, 1) at step 0.01, the system can have 101 candidate threshold values to check. For each candidate threshold value, the system tries to satisfy the performance metrics while maximizing the optimizing metrics. At 204, the system can select the candidate threshold value that maximizes the optimizing metrics. For example, the optimizing metrics can include a good pass-through rate (GPTR). GPTR can be calculated by dividing the amount of legitimate content published by the total amount of legitimate content received. Additionally, the performance metrics can include a live abuse rate (LAR), which can be calculated by determining the amount of abuse that goes live. The GPTR at a specific LAR can be analogous to a precision-recall curve, where high precision relates to a low false positive rate, and high recall relates to a low false negative rate. This is an example of a threshold computation logic that is performed by an automatic threshold mechanism to determine a candidate threshold value.

The candidate threshold value selected at operation 204 can be a threshold for a given slice of data. For example, the slice of data can be associated with changing the location of the hospital having a high risk category. The system can compute the candidate threshold value based on the risk category. For a given threshold, the system can determine if the metric (e.g., performance metric, maximum precision at a given recall) is maximized, the metric in this example being to maximize GPTR at a given LAR. For example, the system can maintain LAR to a given value (e.g., 1%), and select the threshold value that maximizes the GDPR. In another example, the system can select the candidate threshold value that provides the maximum precision at a given recall (e.g., 70%). The risk tolerance associated with the data slice can be captured using the recall rate (e.g., LAR). For example, the system can set an upper bound LAR value (e.g., LAR <1%) to capture the amount of risk the system is willing to accept. As the LAR is increased, so will the GPTR increase. Therefore, the maximum GDPR value when the LAR is set at 2% will be higher than the maximum GPTR value when the LAR is set at 1%, which is similar to other variables associated with precision-recall curves. The threshold value can be selected based on the maximum GDPR value for a given LAR.

At 206, once the candidate threshold value has been selected, the system can check if guardrail metric(s) have been met. In this example, the first guardrail metric can be that the precision value (e.g., GPTR) is equal to or greater than a lower bound value. Additionally, the guardrail metrics can include an upper bound value for the recall value (e.g., LAR). In this example, the second guardrail metric can be that the LAR needs to be equal to or lower than the upper bound value. Moreover, a third guardrail metric can be that the precision value (e.g., GPTR) is greater by a certain percentage (e.g., 5%) than the precision value (e.g., GPTR) obtained from a baseline model (e.g., production model). These guardrail metrics enable the system to incorporate human-like judgment when determining the threshold value.

The system prevents a candidate threshold value from becoming a final threshold value, if the system determines, based on the guardrail metrics, that the candidate threshold value is not usable with real data. For example, based on the maximum GPTR for a given LAR can be 30%, but the guardrail metric may indicate that 30% is unacceptable because the lower bound of the GPTR is 50%. Alternatively, the other extreme would be to have a LAR rate of 0%, which equates to zero abuse, but would also result in zero good content being published. The guardrail metrics enable the avoidance of these extremes and also prevents the model to be hyper optimized on one variable (e.g., parameter) at the detriment of another variable.

At 208, the system determines that the candidate threshold selected at 206 is the final threshold if all or most of the guardrail metrics are satisfied. Alternatively, if one or more of the guardrail metrics have not been satisfied then the system performs a tradeoff logic operation at 210.

At 210, the tradeoff logic operation can incorporate signals (e.g., signals 130 in FIG. 1) in order to decide on the final threshold. At 210, the system performs the tradeoff logic operation to determine a list of options associated with threshold values and select a preferred option from a list of options based on the different signals 130 associated with the input data and the data slice.

In some instances, the threshold(s) for a data slice (e.g., location of a hospital) can be a dependent threshold(s). The dependent threshold can be dependent on multiple signals 130 (e.g., variables) and also dependent on other threshold values of other data slices. The system can incorporate these additional signals to try to satisfy the guardrail metrics. For example, a first data slice can have four different threshold values (i.e., X, Y, Z, and A). The X threshold value can be dependent on the Y threshold value, the Y threshold value can be dependent on the Z threshold value, the Z threshold value can be dependent on the A threshold value, and the A threshold value can be an independent threshold value. In this example, the system can determine a candidate threshold for the independent threshold (i.e., A threshold value), and use the A threshold value with the signals 130 to determine the dependent Z threshold value. Subsequently, the system can use the A threshold value and/or Z threshold value with the signals 130 to determine the dependent Y threshold value. Furthermore, the system can use the A threshold value, Y threshold value, and/or Z threshold value with the signals 130 to determine the dependent X threshold value.

In this example, the slide of data can be hospital locations in the United States. This data slice can have four thresholds, wherein the first (e.g., A) threshold value is whether to publish the input data 110. The second threshold value (e.g., Z) can be to send the input data 110 for manual review. The third threshold value (e.g., Y) can be to deny the input data 110 from being published. The fourth threshold (e.g., X) value can be to ban the user associated with the input data 110. As previously mentioned, the techniques described herein can be performed for both binary classification (e.g., 0 and 1, Yes or No) and discrete-valued (e.g., multi-class output, 3 different output, 4 different output) classification.

According to some embodiments, the system can determine, based on the input data 110, the signal generation 130 and/or the specific data slice, a tradeoff logic operation to perform from a plurality of tradeoff logic operations.

At 212, in some embodiments, the tradeoff logic operations can include the system determining whether the current model with the candidate threshold value is better than the production model (e.g., baseline model) with regards to performance. For example, the system can determine whether the precision value (e.g., GPTR) for a given recall value (e.g., LAR) that is calculated based on the candidate threshold value is better than a production precision value from the production model for the given recall value. The production model can be the machine-learned model that is currently being used by the current system (e.g., mapping application). In some instances, the production model can be the current state of the art associated with binary classifications. If the precision value based on the candidate threshold value is greater than the production precision value, then the candidate threshold value is the final threshold at 214. Alternatively, if the precision value based on the candidate threshold value is greater than the production precision value, then the fallback threshold value is the final threshold at 216. The fallback threshold value can be a threshold value that is preset for a specific data slice. The fallback threshold can be a value that has been selected by a developer of the model that is acceptable when a final threshold value cannot be determined automatically.

At 218, in some embodiments, the tradeoff logic operations can include increasing the acceptable risk tolerance associated with the data slice. In some instances, the system can increase the acceptable risk tolerance for the data slice up to an acceptable upper limit. For example, the LAR for a first data slice can be 1%, but during the tradeoff logic operations, the LAR can be increased incrementally (e.g., to 1.1, 1.2, 1.3 . . . 2.0) up to the acceptable upper limit (e.g., 2.0%). The LAR can be increased by a step value up to the upper limit. In this example, the LAR can start at 1%, and then the system can try 1.01 and see if the guardrail metrics are satisfied. If the guardrail metrics are satisfied, then the candidate threshold value at the specific LAR can become the final threshold value at 220. Alternatively, if the guardrail metrics are not satisfied, then the LAR is increased by the step value (e.g., 0.01) until the guardrail metrics are satisfied or the upper limit value for the LAR has been reached. If the upper limit value has been reached and the guardrail metrics have not been satisfied, then the fallback threshold value can be the final threshold value at 222.

### Example Origination Machine Learning Pipeline

According to some embodiments, the system supports fully customizable thresholds for different data slices. The system can perform both online and offline paths to determine the thresholds. With the online path, the system can receive edits by users in real-time. Subsequently, the system can determine a model score and a threshold value for the data slice.

With the offline path, the system can train a new model by determining a final threshold value for all data slices. The system can annotate edits with matched slice identifiers and determine a candidate threshold value that optimizes the objective of that slice (e.g., such as precision >75% or LAR <1.5%). After getting a candidate threshold value, the system can utilize a model comparator for comparing the candidate model with the production model.

Continuing with the offline path, the system can annotate data slices (e.g., tensorflow. Examples) with slice identifiers. Additionally, the system can automatically determine a threshold for all data slices. Moreover, the system can utilize a model comparator to compare the candidate machine-learned model with the production model. Subsequently, the new slice can be onboard into the machine-learning pipeline.

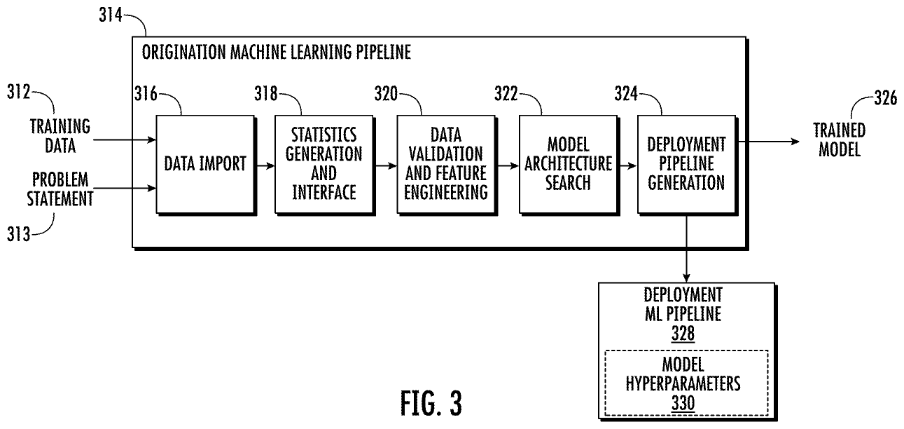

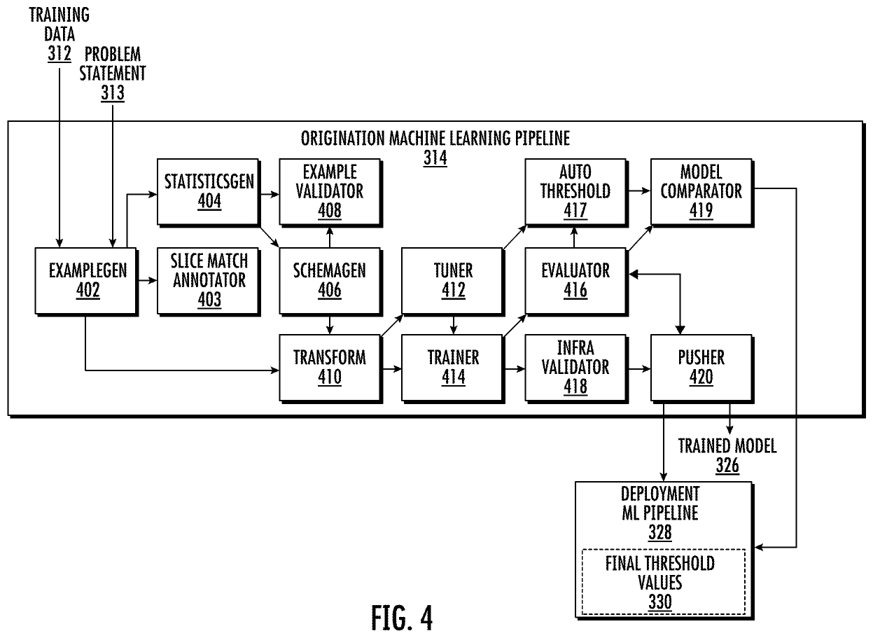

According to some embodiments, exemplary designs and overall flow of the system are depicted in FIGS. 3-4. In some instances, a plurality of TFX components are added to the conventional designs. The plurality of TFX components added can include the slice match annotator, the model comparator, and the auto thresholding component.

FIG. 3 depicts an example origination ML pipeline 314. The example origination ML pipeline 314 illustrated in FIG. 3 can be configured to receive training data 312 (e.g., signals) and, optionally, a problem statement 313 (e.g., input data 110) from a user. Execution of origination ML pipeline 314 can result in generation and exportation of a trained model 326 (e.g., machine-learned model 140) and a deployment ML pipeline 328 that is configured to enable deployment of the trained model 326. In at least one implementation, execution of origination ML pipeline 314 can result in generation and exportation of trained model 326, deployment ML pipeline 328, and/or final threshold values 330 (e.g., threshold values 160) that can correspond to and/or constitute a subset of hyperparameters of deployment ML pipeline 328 and/or trained model 326. In one or more implementations, origination ML pipeline 314 and deployment ML pipeline 328 can each include computer-readable code that automates the workflow it takes to produce and/or run trained model 326.

More particularly, a user can refer to any individual, organization, or computing system operating on behalf of an individual or organization. Example users of the proposed systems can include engineers, analysts, product managers, researchers, platform developers, etc. Users can interact (e.g., by providing input data 110) with the proposed system via a dedicated user interface and/or via an API with defined API calls for certain services. In some implementations, a user can interact with origination ML pipeline 314 via a graphical user interface (GUI) and/or via a programmatic API. For example, in one implementation, an ML platform that provides ML services for various users can request and receive trained model 326, deployment ML pipeline 328 (e.g., including final threshold values 330), and/or any of the pipeline generation services (e.g., deployment pipeline generation 324) described herein from origination ML pipeline 314 via a programmatic API. In this example implementation, origination ML pipeline 314 can receive (e.g., import) training data 312 and, optionally, problem statement 313 (e.g., whether the input data 110 is authentic) from such an ML platform user via the programmatic API, where training data 312 can be associated with the ML platform user and/or one or more individual users associated with the ML platform user. In this example implementation, origination ML pipeline 314 can further export trained model 326 and/or deployment ML pipeline 328 (e.g., including final threshold values 330 such as threshold values 160 for the data slices) to such an ML platform user via the programmatic API, where origination ML pipeline 314 can export trained model 326 and/or deployment ML pipeline 328 (e.g., including final threshold values 330) for deployment of trained model 26 with (e.g., using) deployment ML pipeline 328.

In one example user journey, a user can supply a set of training data 312 (e.g., which may be structured as data for each of a number of features for each of a number of examples). For instance, training data 312 can include and/or constitute a structured training dataset that has data associated with a number of labels. The user can select one of the features as a label (e.g., the feature to be predicted by trained model 326), which may start the search for the best machine learning model. In some implementations, the user may also specify other “advanced” settings from the UI, such as: excluding features, changing feature types, details of the ML task (e.g., corresponding to a problem statement), and details of the search constraints (e.g., corresponding to parameters of an optimization domain associated with a model architecture search). As referenced herein, an “optimization domain” can refer to a list of parameters, their domain (e.g., valid values), and the relationship between them (e.g., one parameter may be conditioned on another one) for an underlying parameterized model.

In some implementations, origination ML pipeline 314 described with reference to FIG. 3 can include and/or otherwise be associated with one or more components that can perform one or more operations associated with data import 316, statistics generation and interface 318, data validation and feature engineering 320, and/or model architecture search 322. In one or more implementations of the present disclosure, such one or more components that can be included in and/or otherwise associated with origination ML pipeline 314 can leverage one or more capabilities of one or more libraries that can be accessed by and/or can provide the base functionality of such one or more components as described below.

FIG. 4 depicts an example, non-limiting alternative implementation of origination ML pipeline 314. The example origination ML pipeline 314 illustrated in FIG. 4 can be configured to receive training data 312 and, optionally, problem statement 313 (e.g., input data 110) from a user (e.g., via a GUI, an API, a REST API, a programmatic API). Execution of origination ML pipeline 314 illustrated in FIG. 4 can result in generation and exportation of trained model 326 (e.g., exportation via a GUI, an API, a REST API, a programmatic API, etc.) and threshold values 160. In at least one implementation, execution of origination ML pipeline 314 illustrated in FIG. 4 can result in generation and exportation (e.g., via a GUI, an API, a REST API, a programmatic API, etc.) of trained model 326 and/or deployment ML pipeline 328 (e.g., including final threshold values 330 including threshold values 160). The example origination ML pipeline 314 and deployment ML pipeline 328 depicted in FIG. 4 can each include computer-readable code that automates the workflow it takes to produce and/or run trained model 326 (e.g., to define, launch, and/or monitor trained model 326).

As illustrated in the example implementation depicted in FIG. 4, origination ML pipeline 314 can include an ExampleGen component 402, a StatisticsGen component 404, a SchemaGen component 406, an Example Validator component 408, a Transform component 410, a Tuner component 412, a Trainer component 414, an Evaluator component 416, an Auto Threshold component 417, an Infra Validator component 418, a model comparator component 419, and/or a Pusher component 420. The example implementation depicted in FIG. 4 illustrates how data can flow between such components of origination ML pipeline 314.

In the example implementation depicted in FIG. 4, ExampleGen component 402 can be configured to receive and format training data 312 and, optionally, problem statement 313 to a format compatible to facilitate one or more operations of one or more components of origination ML pipeline 314. In some implementations, ExampleGen component 402 can be configured to perform such formatting after it splits training data 312 into training and evaluation datasets, which results in two copies of ExampleGen component 402, one each for training and evaluation.

In the example implementation depicted in FIG. 4, the Slice Match Annotator component 403 can receive tensorflow. Example records from Example Gen component 402 to generate annotated records. The Slice Match Annotator component 403 can output model specific configuration which annotates which criteria to optimize for which slice. For example, the Slice Match Annotator component 403 can include the following code:

```
feature {
  key: “slice_id”
  value {
    bytes_list {
    # Unique string used to identify the data slice.
    value: “gmb_deny” } } }
```

In the example implementation depicted in FIG. 4, the StatisticsGen component 404 can be configured to receive the formatted training data 312 from ExampleGen component 402. In this implementation, StatisticsGen component 404 can be configured to examine the formatted training data 312 and infer (e.g., calculate) one or more statistics corresponding to such formatted training data 312. In this way, StatisticsGen component 404 can be configured to generate one or more statistics descriptive of training data 312.

In some implementations, the StatisticsGen component 404 can also perform a statistical analysis to generate new features from the raw data. For example, the StatisticsGen component 404 can perform various statistical measures such as adjusted mutual information to understand correlations between different features that may enable the generation of additional feature data reflective or demonstrative of such correlations. The StatisticsGen component 404 can suggest the new features to the user and/or automatically generate and populate the new feature data.

In another example, new features can be automatically or manually generated by searching over large sets of data crosses to find correlations between feature crosses and labels. The StatisticsGen component 404 or Transform component 410 discussed below can suggest the new features to the user and/or automatically generate and populate the new feature data. For example, the StatisticsGen component 404 or Transform component 410 discussed below can provide a user interface by which a user can provide input data 110 and view the respective signals to different data slices, enabling the user to unlock additional levels of data insight, understanding, and interpretability. In addition, users can be enabled to use a relational database (e.g., paired with a structured query language) to create custom features on the fly.

In one or more implementations, origination ML pipeline 314 and/or StatisticsGen component 404 can be configured to store metadata descriptive of such one or more statistics in a library and/or a memory device that can be accessed by origination ML pipeline 314 and/or one or more components thereof to retrieve the metadata descriptive of the one or more statistics. For example, origination ML pipeline 314 and/or StatisticsGen component 404 can be configured to store metadata descriptive of such one or more statistics in a machine learning (ML) metadata library and/or a memory device that can be accessed by origination ML pipeline 314 and/or one or more components thereof to retrieve the metadata descriptive of the one or more statistics.

In the example implementation depicted in FIG. 4, SchemaGen component 406 can be configured to receive the formatted training data 312 and/or the above-described statistics corresponding to such formatted training data 312 from StatisticsGen component 404. In this implementation, SchemaGen component 406 can be configured to examine such statistics and infer a data schema corresponding to the formatted training data 312. As referenced herein, “schema” can refer to a description of training data 312 that can be used by one or more components of origination ML pipeline 314. In some implementations, a schema as defined herein can include and/or constitute an instance and/or a type of a protocol buffer (also referred to as a “protobuf”). In some implementations, the schema can specify, for instance: data type(s) for feature value(s); whether a feature is to be present in all examples; allowed value ranges; and/or another property of training data 312.

In some implementations, the SchemaGen component 406 can be configured to use logic or heuristics to evaluate each feature and output a detected semantic type. Example semantic types include text, image, numerical, etc. As one example, if the feature values contain values that are contained within a color range and demonstrate a repeating structure common to imagery, then the tool can detect that the semantic type is imagery. In another example, if the features values contain only numerical numbers that do not demonstrate a repeating structure common to imagery, then the tool can detect that the semantic type is numerical. Likewise, if the features values contain only textual information, then the tool can detect that the semantic type is textual. The SchemaGen component 406 can automatically label the features with the detected semantic type.

In one or more implementations, origination ML pipeline 314 and/or SchemaGen component 406 can be configured to store metadata descriptive of such a data schema in a library and/or a memory device that can be accessed by origination ML pipeline 314 and/or one or more components thereof to retrieve the metadata descriptive of the data schema. For example, origination ML pipeline 314 and/or SchemaGen component 406 can be configured to store metadata descriptive of such a data schema in an ML metadata library and/or a memory device that can be accessed by origination ML pipeline 314 and/or one or more components thereof to retrieve the metadata descriptive of the data schema.

In the example implementation depicted in FIG. 4, Example Validator component 408 can be configured to receive the above-described statistics and data schema from StatisticsGen component 404 and SchemaGen component 406, respectively. In this implementation, Example Validator component 408 can be configured to examine such statistics and data schema to identify any anomalies, missing values, and/or incorrect data types in the formatted training data 312.

In some implementations, to perform one or more of the above-described operations, ExampleGen component 402, StatisticsGen component 404, SchemaGen component 406, and/or Example Validator component 408 can be configured to leverage one or more capabilities of one or more libraries that can be accessed by and/or can provide the base functionality of such component(s) of origination ML pipeline 314. For example, in these implementations, such component(s) of origination ML pipeline 314 can be configured to leverage one or more libraries written in the Python programming language that provide the base functionality of such component(s). For instance, in one or more implementations, ExampleGen component 402, StatisticsGen component 404, SchemaGen component 406, and/or Example Validator component 408 can be configured to leverage one or more capabilities of a validation library (e.g., a tensorflow validation library). In these one or more implementations, such component(s) of origination ML pipeline 314 can be configured to leverage one or more capabilities of such a validation library to, for instance, perform initial exploration, visualization, and/or cleaning of training data 312. In these one or more implementations, such component(s) of origination ML pipeline 314 can be configured to leverage one or more capabilities of such a validation library to, for instance: examine training data 312 and infer the data types, categories, and/or ranges in training data 312 (e.g., via StatisticsGen component 404 and/or SchemaGen component 406); and/or identify anomalies, missing values, and/or incorrect data types in training data 312 (e.g., via Example Validator component 408).

In some implementations, ExampleGen component 402, StatisticsGen component 404, SchemaGen component 406, and/or Example Validator component 408 can be configured to leverage one or more capabilities of the above-described validation library and/or one or more visualization tools thereof to enable origination ML pipeline 314 and/or a user to examine and understand training data 312 (e.g., via metadata corresponding to training data 312). In some implementations, origination ML pipeline 314 and/or the user can query a machine learning metadata library to locate results of the executions of ExampleGen component 402, StatisticsGen component 404, SchemaGen component 406, and/or Example Validator component 408 and then use such one or more visualization tools (e.g., a visualization support API) of the validation library to create and/or view (e.g., via a monitor of a computing device associated with the user) such results of the executions (e.g., the above-described statistics, schema, etc.). In these implementations, after multiple executions of ExampleGen component 402, StatisticsGen component 404, SchemaGen component 406, and/or Example Validator component 408, origination ML pipeline 314 and/or the user can employ such one or more visualization tools to compare results corresponding to each of such multiple executions and then make adjustments as needed until origination ML pipeline 314 and/or the user is satisfied that training data 312 is in a desirable state to train a model such that it operates according to a certain application that can be defined by the user (e.g., via problem statement 313).

In at least one implementation, the above-described validation library can include and/or constitute a scalable library that can facilitate analyzing and/or validating machine learning data. In this implementation, such a validation library can facilitate operations that can include, but are not limited to: scalable calculation of summary statistics of training and test data; integration with a viewer for data distributions and statistics and/or faceted comparison of pairs of datasets; automated data-schema generation to describe expectations about data such as, for example, required values, ranges, and/or vocabularies; inspection of the schema via, for instance, a schema viewer; anomaly detection to identify anomalies such as, for example, missing features, out-of-range values, and/or wrong feature types; inspection of such anomalies via, for instance, an anomalies viewer to enable a user to see what features have anomalies and learn more in order to correct them; and/or another operation.

In some implementations, after an initial model training and deployment (e.g., training and deployment of trained model 26), ExampleGen component 402, StatisticsGen component 404, SchemaGen component 406, and/or Example Validator component 408 can each be configured to leverage one or more capabilities of the above-described validation library to, for instance: monitor new data from inference requests submitted to trained model 26 after it has been deployed by origination ML pipeline 314 as described below; and/or identify anomalies and/or drift. In these implementations, such operations are beneficial when applied to time series data that changes over time as a result of a trend or seasonality and can further help inform a user when there are data problems or when trained model 26 needs to be retrained on new data. In these implementations, another benefit of such a validation library is that it can be used (e.g., by SchemaGen component 406) to generate a schema by inferring data types, categories, and/or ranges from training data 312.

In the example implementation depicted in FIG. 4, Transform component 410 can be configured to perform feature engineering on training data 312. For example, in at least one implementation, Transform component 410 can be configured to receive the above-described formatted and/or split training data 312, statistics, and schema and apply data transformations to create, combine, and/or transform the features that will be used to train a candidate ML model (e.g., a certain ML architecture that can be instantiated, trained, and/or evaluated as described herein in accordance with one or more implementations). In this at least one implementation, Transform component 410 can be configured to further cleanup missing values and/or convert data types corresponding to training data 312. For instance, Transform component 410 can be configured to clean up missing values and/or convert data types corresponding to training data 312 in implementations where there is a possibility that these will also be present in data sent for inference requests (e.g., to trained model 26).

In some implementations, to perform the above-described feature engineering operations, Transform component 410 can be configured to leverage one or more capabilities of one or more libraries that can be accessed by and/or can provide the base functionality of Transform component 410. For example, in these implementations, Transform component 410 can be configured to leverage one or more capabilities of one or more libraries written in the Python programming language that provide the base functionality of Transform component 410. For instance, in one or more implementations, Transform component 410 can be configured to leverage one or more capabilities of a transform library that can facilitate preprocessing of training data 312. By way of example, in these one or more implementations, Transform component 410 can be configured to leverage one or more capabilities of such a transform library to perform preprocessing operations on training data 312 that can include, but are not limited to: normalizing an input value by mean and standard deviation; converting strings to integers by generating a vocabulary over all input values; converting floats to integers by assigning them to buckets based on the observed data distribution; and/or another operation.

In some implementations, the output of Transform component 410 can include and/or constitute a serialization of a model that can be referred to herein as a “SavedModel” and can include all the data engineering transformations that were created by Transform component 410. As referenced herein, a “SavedModel” can refer to a universal, language-neutral, hermetic, recoverable serialization of a model. For example, a SavedModel as referenced herein can include and/or constitute the recommended serialization format that can be used by origination ML pipeline 314 and/or one or more components thereof to serve a model in production or export a trained model for a certain computing device (e.g., a smart phone, tablet, etc.) and/or a certain software application (e.g., a software application written in a certain language). For instance, to facilitate conversion of a model into a representational state transfer (REST) service to make predictions, origination ML pipeline 314 can serialize a model as a SavedModel and serve it (e.g., using one or more capabilities of a serving library). In the above examples, a benefit of such a SavedModel is that it enables higher-level systems to produce, transform, and/or consume models using a single abstraction. Additionally, and/or alternatively, a “model” as referenced herein can refer to the output of a training process. For example, a model as referenced herein can include and/or constitute the serialized record of weights that have been learned during the training process and/or weights that have been learned up to a certain point in the training process. In some implementations of the present disclosure, such weights can be subsequently used to compute predictions for new input examples.

In some implementations described herein, Tuner component 412 can be configured to search an optimization domain as defined herein to identify a candidate ML model (hereinafter, “candidate model”) having a certain ML model architecture (e.g., certain parameters, hyperparameters, final threshold values 330, etc.) that can satisfy an objective of a user (e.g., an objective defined in problem statement 313, optimizing the performance metric at a given risk tolerance value). In these implementations, such a search of the optimization domain can constitute an ML model architecture search that can be performed by Tuner component 412 to identify one or more candidate models that can be instantiated, trained, evaluated, and/or deployed as described herein in accordance with one or more implementations of the present disclosure.

In some implementations, to perform the above-described ML model architecture search to identify a candidate model, Tuner component 412 can be configured to select a number of seed or initial models or model types based on the feature data. In one example, a list of constraints can be identified, where the constraints indicate types (e.g., semantic types) of feature data that the resulting model should be able or optimized to process. As one example, constraints can be specified by the user. Additionally, or alternatively, the constraints can correspond to or be derived from the semantic types that were automatically detected by the SchemaGen component 406.

The Tuner component 412 can use the constraints to select a number of seed or initial models or model types (e.g., from a list of candidate models or model types). For example, the Tuner component 412 can use logic (e.g., encoded in a look up table) to identify models or model types that satisfy the constraints. As one example, if the semantic type of a feature is imagery, then the Tuner component 412 may limit the seed or initial models to convolutional neural networks, vision transformers, or other models or model types that are known to provide superior performance relative to imagery.

In some implementations, to perform the above-described ML model architecture search to identify a candidate model, Tuner component 412 can be configured to employ an algorithm that can search the optimization domain to identify the relatively best ML model architecture (e.g., parameters, hyperparameters, final threshold values 330, etc.) based on a certain objective (e.g., an objective that can be defined by a user in problem statement 313). For instance, Tuner component 412 can be configured to employ a search algorithm, a tuner algorithm, a Gaussian algorithm and/or process, a neural architecture search (NAS) algorithm, a reinforcement learning (RL) algorithm, and/or another algorithm to identify the relatively best ML model architecture (e.g., parameters, hyperparameters, final threshold values 330, etc.) based on a certain objective (e.g., an objective that can be defined by a user in problem statement 313). In some implementations, to perform the ML model architecture search and/or identify the one or more candidate models, Tuner component 412 can be configured to leverage one or more capabilities of one or more libraries that can be accessed by and/or can provide the functionality of Tuner component 412. For example, in these implementations, Tuner component 412 can be configured to leverage one or more capabilities of one or more libraries written in the Python programming language that can enable Tuner component 412 to perform the ML model architecture search and/or identify the one or more candidate models.

In some implementations, Tuner component 412 can be configured to perform the above-described ML model architecture search based at least in part on training data 312, problem statement 313, and/or one or more attributes corresponding to training data 312 and/or problem statement 313. For instance, in an example implementation, Tuner component 412 can be configured to perform the ML model architecture search based at least in part on metadata descriptive of training data 312, problem statement 313, and/or one or more attributes corresponding to training data 312 and/or problem statement 313. For example, Tuner component 412 can be configured to perform the ML model architecture search based at least in part on the above-described metadata descriptive of the statistics and/or schema that can be stored in, for instance, an ML metadata library by StatisticsGen component 404 and SchemaGen component 406, respectively.

In another example implementation, Tuner component 412 can be configured to infer, based on problem statement 313, one or more parameters of the optimization domain to identify such a candidate model having a certain ML model architecture (e.g., certain parameters, hyperparameter, final threshold values 330, etc.). In another example implementation, Tuner component 412 and/or one or more other components of origination ML pipeline 314 (e.g., ExampleGen component 402, StatisticsGen component 404, SchemaGen component 406, Example Validator component 408, and/or Transform component 410) can be configured to detect a semantic type for one or more features of a plurality of features included in training data 312. In this example implementation, Tuner component 412 can be configured to perform the above-described ML model architecture search based at least in part on such detected semantic type for one or more features of a plurality of features included in training data 312. For instance, in this example implementation, Tuner component 412 can be configured to constrain the ML model architecture search to candidate model architectures capable of processing the semantic type detected for the one or more features of the plurality of features included in training data 312.

In some implementations, the output of Tuner component 412 can include and/or constitute one or more parameters and/or hyperparameters (e.g., values of one or more parameters and/or hyperparameter) of a candidate model that can be identified by Tuner component 412 when searching an optimization domain as described above. For example, in some implementations, the output of Tuner component 412 can include and/or constitute final threshold values 330 (e.g., final threshold values 330), which can constitute hyperparameters of a candidate model that can be identified by Tuner component 412 when searching an optimization domain as described above. In these or other implementations, origination ML pipeline 314 and/or Tuner component 412 can be configured to store such one or more parameters and/or hyperparameters (e.g., to store final threshold values 330). In one or more implementations, origination ML pipeline 314 and/or Tuner component 412 can be configured to store metadata descriptive of such one or more parameters and/or hyperparameters (e.g., final threshold values 330) in a library and/or a memory device that can be accessed by origination ML pipeline 314 and/or one or more components thereof to retrieve the metadata descriptive of the one or more parameters and/or hyperparameters. For example, in one implementation, origination ML pipeline 314 and/or Tuner component 412 can be configured to store metadata descriptive of such one or more parameters and/or hyperparameters (e.g., final threshold values 330) in a library an ML metadata library and/or a memory device that can be accessed by origination ML pipeline 314 and/or one or more components thereof to retrieve the metadata descriptive of the one or more parameters and/or hyperparameters. In this implementation, storing such metadata descriptive of the one or more parameters and/or hyperparameters (e.g., final threshold values 330) in such a library and/or a memory device can constitute storing metadata descriptive of the performance (e.g., results) of the above-described ML model architecture search of the optimization domain that can be performed by Tuner component 412.

In some implementations of the present disclosure, Tuner component 412 can be configured to tune one or more parameters and/or hyperparameters of a candidate model. In some implementations (e.g., as described below with reference to FIG. 4), Tuner component 412 can be configured to re-tune one or more parameters and/or hyperparameters of a previously trained model (e.g., trained model 26). For example, in some implementations, Tuner component 412 can be configured to tune one or more parameters and/or hyperparameters such as, for instance, number of layers of the candidate model and/or another parameter and/or hyperparameter. In an example implementation, Tuner component 412 can be configured to tune one or more parameters and/or hyperparameters of a candidate model based on (e.g., using and/or according to) the stored metadata descriptive of training data 312 and the performance (e.g., results) of the above-described ML model architecture search that can be performed by Tuner component 412. In this example implementation, such tuning of one or more parameters and/or hyperparameters of a candidate model based on the stored metadata descriptive of training data 312 and the performance (e.g., results) of the above-described ML model architecture search can constitute tuning of one or more parameters and/or hyperparameters of and/or associated with origination ML pipeline 314 based on such stored metadata.

In these implementations, to tune one or more parameters and/or hyperparameters of a candidate model, Tuner component 412 can be configured to employ an algorithm that can search the above-described optimization domain to identify the relatively best parameters (e.g., threshold values) and/or hyperparameters (e.g., threshold values) for the candidate model based on a certain objective (e.g., an objective that can be defined by a user in problem statement 313). For instance, Tuner component 412 can be configured to employ a search algorithm, a tuner algorithm, a Gaussian algorithm and/or process, a neural architecture search (NAS) algorithm, a reinforcement learning (RL) algorithm, and/or another algorithm to identify the optimal parameters and/or hyperparameters for the candidate model. In some implementations, to tune one or more parameters and/or hyperparameters of a candidate model, Tuner component 412 can be configured to leverage one or more capabilities of one or more libraries that can be accessed by and/or can provide the functionality of Tuner component 412. For example, in these implementations, Tuner component 412 can be configured to leverage one or more capabilities of one or more libraries written in the Python programming language that can enable Tuner component 412 to tune such one or more parameters and/or hyperparameters of the candidate model.

In the example implementation depicted in FIG. 4, Trainer component 414 can be configured to train a candidate model. For example, in some implementations, Trainer component 414 can be configured to receive the above-described SavedModel, candidate model, and/or one or more parameters and/or hyperparameters of the candidate model from Transform component 410 and/or Tuner component 412. In these implementations, the SavedModel and/or candidate model can include all the data engineering transformations that were created by Transform component 410 such that the identical transforms can be performed using the exact same computer-readable code during both training and inference (e.g., the above-described computer-readable code that can be included in and/or used by origination ML pipeline 314 to automate the workflow it takes to produce and/or run trained model 26). In these implementations, by using such exact same computer-readable code (also referred to herein as “modeling code”), including the SavedModel and/or candidate model, Trainer component 414 can consume training data 312 (e.g., training data 312 that has been split into training and evaluation data) and train the candidate model.

In some implementations, to train a candidate model, Trainer component 414 can be configured to leverage one or more capabilities of one or more libraries that can be accessed by and/or can provide the base functionality of Trainer component 414. For example, in these implementations, Trainer component 414 can be configured to leverage one or more capabilities of one or more libraries written in the Python programming language that provide the base functionality of Trainer component 414. For instance, in one or more implementations, Trainer component 414 can be configured to leverage one or more capabilities of a library (e.g., a tensorflow library) that ingests training data and modeling code and creates a SavedModel result. In these one or more implementations, such a library can also integrate a feature engineering pipeline that can be created by Transform component 410 to preprocess input data (e.g., training data 312).

In implementations involving an Estimator based model, Trainer component 414 can be configured to save a trained candidate model as both a SavedModel and an “EvalSavedModel” that becomes the basis for the analysis performed by Evaluator component 416 as described below. In these implementations, saving such a trained candidate model as an EvalSavedModel ensures the metrics used at training time are also available during evaluation by Evaluator component 416. In these implementations, to facilitate saving the trained candidate model as an EvalSavedModel, Trainer component 414 can be configured to leverage one or more capabilities of a library that can be accessed by and/or can provide the functionality of Trainer component 414. For example, in these implementations, Trainer component 414 can be configured to leverage one or more capabilities of a model analysis library described below with reference to Evaluator component 416.

In the example implementation depicted in FIG. 4, Evaluator component 416 can be configured to perform a deep analysis of training results from training a candidate model (e.g., via Trainer component 414) and to facilitate validation of such a candidate model to ensure it is satisfactory to be pushed to production. In some implementations, following initial model development and training as described above, Evaluator component 416 can be configured to analyze the model's performance and generate rescored dumps. For example, in these implementations, Evaluator component 416 can be configured to receive a trained model (e.g., as a SavedModel) and analyze the model's performance based on a slice of training data 312 (e.g., a list of data items, features, labels, etc. of training data 312). For instance, in these implementations, Evaluator component 416 can be configured to analyze the model's performance against a slice of training data 312 including one or more particular categories for categorical features, one or more particular ranges for numerical features, and/or another slice of training data 312.

In the above implementations, such analysis of the performance of a trained candidate model against such a slice of training data 312 can be beneficial in understanding the model's performance with respect to, for instance, different segments of entities (e.g., customers) associated with origination ML pipeline 314 and/or the outputs thereof (e.g., trained model 326 and/or deployment ML pipeline 328). In these implementations, Evaluator component 416 can be configured to segment the entities by, for instance, user account data, geographical data, age group, gender, and/or another attribute.

In some implementations, to evaluate the performance of a trained candidate model, Evaluator component 416 can be configured to leverage one or more capabilities of one or more libraries that can be accessed by and/or can provide the base functionality of Evaluator component 416. For example, in these implementations, Evaluator component 416 can be configured to leverage one or more capabilities of one or more libraries written in the Python programming language that provide the base functionality of Evaluator component 416. For instance, in one or more implementations, Evaluator component 416 can be configured to leverage one or more capabilities of a model analysis library. In these one or more implementations, Evaluator component 416 can be configured to leverage such one or more capabilities of the model analysis library to create an EvalSavedModel that then becomes the basis for the analysis by Evaluator component 416. In these one or more implementations, such a model analysis library can enable Evaluator component 416 to evaluate a trained candidate model on large amounts of data in a distributed manner, using the same metrics defined by Trainer component 414. In some implementations, such metrics can be computed over different slices of training data 312 and/or visualized for viewing by, for instance, a user implementing origination ML pipeline 314.

In some implementations, Evaluator component 416 can be configured to leverage one or more capabilities of the above-described model analysis library and/or one or more visualization tools thereof to enable origination ML pipeline 314 and/or a user to examine and understand results of the model performance analysis that can be performed by Evaluator component 416 as described above. In some implementations, origination ML pipeline 314 and/or the user can query a machine learning metadata library to locate results of the executions of Evaluator component 416 and then use such one or more visualization tools (e.g., a visualization support API) of the model analysis library to create and/or view (e.g., via a monitor of a computing device associated with the user) such results of the executions (e.g., the above-described performance results with respect to one or more slices of training data 312). In these implementations, after multiple executions of Evaluator component 416 (e.g., multiple performance analyses of the trained candidate model against different slices of training data 312), origination ML pipeline 314 and/or the user can employ such one or more visualization tools to compare results corresponding to each of such multiple executions and then make adjustments to the trained candidate model as needed (e.g., via Transform component 410, Trainer component 414, Tuner component 412, etc.) until origination ML pipeline 314 and/or the user is satisfied that the model and/or the results produced by the model can achieve a certain objective and/or application that can be defined by the user (e.g., via problem statement 313).

In some implementations, as part of analyzing the performance of a trained candidate model, Evaluator component 416 can be configured to validate the performance of the model against a baseline such as, for instance, a currently serving model (e.g., a model currently executing on an infrastructure of a computing system). In these implementations, Evaluator component 416 can be configured to receive both a trained candidate model (e.g., as a SavedModel) and a baseline model (e.g., a model currently executing on a computing system infrastructure). In these implementations, Evaluator component 416 can be configured to compute metrics (e.g., area under the curve (AUC), loss, etc.) for both the trained candidate model and the baseline model along with, for instance, a corresponding set of diff metrics. In these implementations, origination ML pipeline 314 and/or Evaluator component 416 can then apply and use one or more thresholds to gate push the trained candidate model and/or one or more other models (e.g., one or more other SavedModels) subsequently generated by origination ML pipeline 314 to production.

In the example implementation depicted in FIG. 4, the Auto Threshold component 417 can determine threshold values 160 for each data slice. The Auto Threshold component 417 can receive the outputs of the Tuner component 412 and the Evaluation component 416 to determine a threshold value 160 for each data slice in the plurality of data slices. In some instances, for determining the threshold value 160 for each slice, the Auto Threshold component 417 can receive the output (e.g., rescored dumps) from the Evaluator component 416 and the output from the Slice Match Annotator 403. As previously mentioned, the Slice Match Annotator 403 can generate model specific configuration that annotates the criteria for each slice to optimize for. The Evaluator component 416 can generate the rescored dump by consuming candidate model from the trainer component and annotates tf. Example records to produce rescored dumps.

The Auto Threshold component 417 can include a calibration layer for marginal precision calculation. In prior systems, the Auto Threshold component 417 can calibrate the scores, get the optimal threshold, and then undo the calibration on the returned threshold. In the techniques described herein, the Auto Threshold component 417 can have a calibrated model in order to obtain the calibrated scores directly. For example, AutoTFX performs calibration for all binary classification models. But the “default” score returned by the Classify API still returns the uncalibrated score.

In some instances, the Auto Threshold component 417 can execute an auto thresholding algorithm to determine a candidate threshold value 160. For example, the auto thresholding algorithm can be described by the example below. For each slice, the system can specify the metrics that we want to optimize in the auto threshold config file as described in the example below.

```
{
  {
    slice_name: “eot_deny”
    data_slice: {
      slice_definition: {
        feature_key: “edit_type”
        feature_value: “EOT”
        }
      }
      optimizing_metric: {
        metric_name: “good_pass_through_rate_weighted”
      }
      performance_constraints: {
        metric_name: “published_abuse_rate_weighted”
        upper_bound: 0.05 } } }
```

For example, from 0.0 to 1.0 at step 0.01, there are 101 threshold options. At all the different threshold values, the Auto Threshold component 417 first checks if performance constraints are met. If that is satisfied, then Auto Threshold component 417 adds that threshold as candidate thresholds. Then for all candidate threshold values, the Auto Threshold component 417 can determine the final threshold value that maximizes the optimizing metric. The final threshold value can be the optimal threshold for the current slice. In some instances, prior to the candidate threshold being selected as the final threshold value, the Auto Threshold component 417 ensures that certain guardrails are satisfied. If the guardrails are not satisfied, then the Auto Threshold component 417 can perform a tradeoff operation as described in FIG. 2.

In the example implementation depicted in FIG. 4, Infra Validator component 418 can be configured to determine whether a trained candidate model is servable from a certain infrastructure (e.g., an infrastructure of a computing system and/or device associated with origination ML pipeline 314). In one or more implementations, Infra Validator component 418 can be configured to determine whether a trained candidate model is servable in a production environment to ensure that such a model does not prevent the system from serving predictions. In these one or more implementations, to perform such a determination, Infra Validator component 418 can be configured to implement a canary deployment of the trained candidate model in a sandboxed environment (e.g., a deployment of the model in a canary model server), and optionally send real requests to check that the trained candidate model works correctly. In some implementations, if it is determined by Infra Validator component 418 that the trained candidate model is not servable from such a certain infrastructure, Infra Validator component 418 can prevent such a model from being pushed to production.

In the example implementation depicted in FIG. 4, the Model Comparator component 419 can determine if the performance of the candidate model is better than the baseline model (e.g., production model). The Model Comparator component 419 can receive the output of the Auto Threshold 417 and the Evaluator component 416 to decide on whether the performance of the candidate machine-learned model or the baseline machined-learned model is better. In some instances, when the performance of the candidate model is better, then the threshold value determined by the Auto Threshold component can be the final threshold value used by the system to determine whether input data 110 is authentic. In these implementations, Model Comparator component 419 can be configured to receive both a trained candidate model (e.g., as a SavedModel) and a baseline model (e.g., a model currently executing on a computing system infrastructure). In these implementations, Model Comparator component 419 can be configured to compute metrics (e.g., area under the curve (AUC), loss, etc.) for both the trained candidate model and the baseline model along with, for instance, a corresponding set of diff metrics in order to determine which model performs better.

In the example implementation depicted in FIG. 4, Pusher component 420 can be configured to deploy a trained model (e.g., a SavedModel, trained candidate model, trained model 326, etc.) generated by origination ML pipeline 314 onto a serving infrastructure where such a model can receive inference requests. For example, in implementations where Infra Validator component 418 determines that a trained model (e.g., a SavedModel, trained candidate model, trained model 326, etc.) is servable from a certain serving infrastructure, Pusher component 420 can be configured to deploy the model onto the serving infrastructure. In some implementations, such deployment by Pusher component 420 onto such a serving infrastructure can include handling (e.g., deploying, managing, implementing, modifying, etc.) multiple versions of the trained model and/or model updates corresponding to the trained model and/or multiple versions thereof (e.g., via deployment ML Pipeline 328 and/or final threshold values 330 as described below with reference to FIG. 3).

In some implementations, to deploy such a trained model (e.g., a SavedModel, trained candidate model, trained model 326, etc.) onto a serving infrastructure, Pusher component 420 can be configured to leverage one or more capabilities of a library and/or a system that can serve machine learning models in a production environment. For example, in these implementations, Pusher component 420 can be configured to leverage one or more capabilities of a serving system that can consume a SavedModel and accept inference requests via an interface component (e.g., a REST API). In these implementations, such a service system that can be employed by Pusher component 420 to deploy a trained model onto a service infrastructure can be configured to run as a set of processes on one or more network servers, using one of several advanced architectures to handle synchronization and distributed computation.

### Example Deployment Machine Learning Pipeline

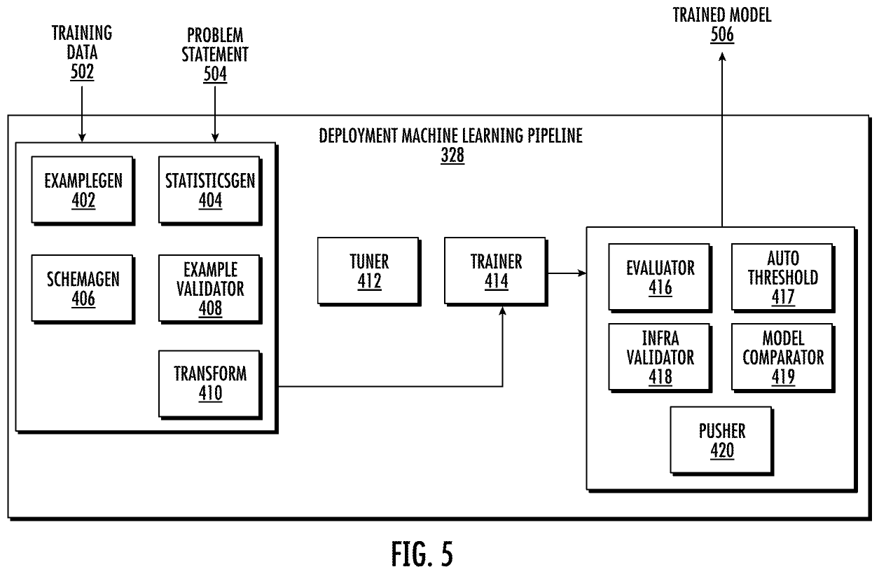

FIG. 5 depicts an example, non-limiting implementation of deployment ML pipeline 328. The example deployment ML Pipeline 328 illustrated in FIG. 5 can be configured to receive training data 502 and, optionally, problem statement 504 from a user (e.g., via a GUI, an API, a REST API, a programmatic API, etc.). Execution of deployment ML Pipeline 328 illustrated in FIG. 5 can result in generation and exportation of trained model 506 (e.g., exportation via a GUI, an API, a REST API, a programmatic API, etc.). The example deployment ML Pipeline 328 depicted in FIG. 5 can include computer-readable code that automates the workflow it takes to produce and/or run trained model 506 (e.g., to define, launch, and/or monitor trained model 506).

As illustrated in the example implementation depicted in FIG. 5, deployment ML Pipeline 328 can include ExampleGen component 402, StatisticsGen component 404, SchemaGen component 406, Example Validator component 408, Transform component 410, Tuner component 412, Trainer component 414, Evaluator component 416, Auto Threshold component 417, Infra Validator component 418, model comparator component 419 and/or Pusher component 420, which can perform their respective operations in the same manner as described above with reference to FIG. 4. The example implementation depicted in FIG. 5 illustrates how data can flow between such components of deployment ML Pipeline 328.

In the example implementation illustrated in FIG. 5, Trainer component 414 can be configured to retrain an ML model. For example, in this implementation, following execution of origination ML pipeline 314 to generate and/or deploy trained model 326 and/or deployment ML pipeline 328 (e.g., including final threshold values 330) as described above with reference to FIG. 4, Trainer component 414 can retrain trained model 326 based on (e.g., using) training data 502 and, optionally, problem statement 504. In this implementation, training data 502 can include training data that is different from that of training data 312 and/or problem statement 313 can include a problem definition that is different from that of problem statement 313.

In the example implementation depicted in FIG. 5, ExampleGen component 402, StatisticsGen component 404, SchemaGen component 406, Example Validator component 408, and/or Transform component 410 can be configured to perform their respective operations (e.g., operations described above with reference to FIG. 4) on training data 502 and/or problem statement 504 in the same manner as they performed such operations on training data 312 and/or problem statement 313. In this implementation, based on the respective outputs of such components that can be produced for training data 502 and, optionally, problem statement 504, Trainer component 414 can use such outputs to retrain trained model 326 and thereby produce trained model 506. In some implementations of the present disclosure, Trainer component 414 can be configured to retrain trained model 326 with (e.g., using) a fixed list of feature columns and thereby produce trained model 506. In the example implementation depicted in FIG. 5, Evaluator component 416, Auto Threshold component 417, Infra Validator component 418, model comparator component 419, and/or Pusher component 420 can be configured to perform their respective operations (e.g., operations described above with reference to FIG. 4) on trained model 506 such that after a satisfactory evaluation of trained model 506 (e.g., via Evaluator component 416, Model comparator component 419) and a satisfactory evaluation of a target deployment infrastructure (e.g., via Infra Validator 418), Pusher component 420 can deploy trained model 506 to the target deployment infrastructure.

### Example Methods

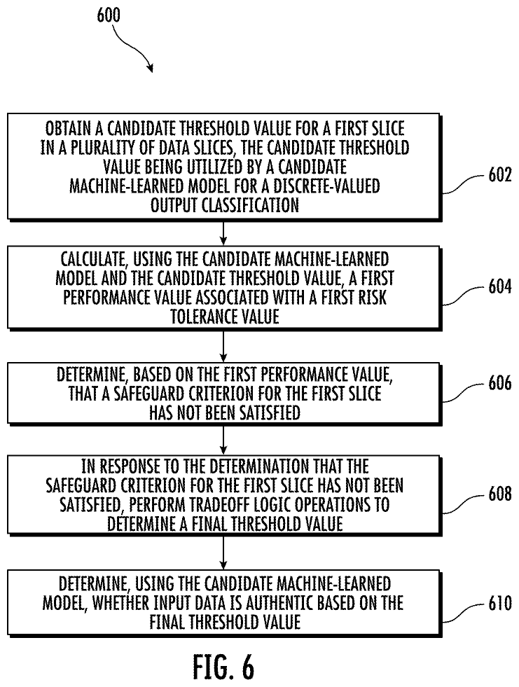

FIG. 6 depicts a flow chart diagram of an example method to perform according to example embodiments of the present disclosure. Although FIG. 6 depicts steps performed in a particular order for purposes of illustration and discussion, the methods of the present disclosure are not limited to the particularly illustrated order or arrangement. The various steps of method 600 can be omitted, rearranged, combined, and/or adapted in various ways without deviating from the scope of the present disclosure.

At 602, a computing system can obtain a candidate threshold value for a first slice in a plurality of data slices. The candidate threshold value can be utilized by a candidate machine-learned model for a discrete-valued output classification. In some instances, the discrete-valued output classification can be a binary classification.

At 604, the computing system can calculate, using the candidate machine-learned model and the candidate threshold value, a first performance value associated with a first risk tolerance value. In some instances, the first performance value can be a good pass-through rate (GPTR), and the first risk tolerance value can be a live abuse rate (LAR). For example, the system can calculate, using the candidate machine-learned model and the candidate threshold value, the GPTR at a LAR of 1%.

At 606, the computing system can determine, based on the first performance value, that a safeguard criterion for the first slice has not been satisfied. In some instances, the safeguard criterion for the first slice has not been satisfied when the first performance value is below a lower limit threshold (e.g., 50%, 75%, 95%) associated with a performance metric (e.g., GPTR).

At 608, in response to the determination that the safeguard criterion for the first slice has not been satisfied, the computing system can perform tradeoff logic operations to determine a final threshold value.

In some instances, the tradeoff logic operations can include: increasing the first risk tolerance value by a step value to obtain a second risk tolerance value; calculating, using the candidate machine-learned model and the candidate threshold value, a second performance value associated with the second risk tolerance value; determining, based on the second performance value, that the safeguard criterion for the first slice has been satisfied; and in response to the determination that the safeguard criterion for the first slice has been satisfied, selecting the final threshold value to be the candidate threshold value. For example, the first performance value increases when the first risk tolerance value increases, and the second performance value can be larger than the first performance value.

In some instances, the tradeoff logic operations can include: increasing the first risk tolerance value by a step value to obtain a second risk tolerance value; calculating, using the candidate machine-learned model and the candidate threshold value, a second performance value associated with the second risk tolerance value; determining, based on the second performance value, that the safeguard criterion for the first slice has not been satisfied; in response to the determination that the safeguard criterion for the first slice has not been satisfied, increasing the second risk tolerance value by the step value to obtain a third risk tolerance value; calculating, using the candidate machine-learned model and the candidate threshold value, a third performance value associated with the third risk tolerance value; determining, based on the third performance value, that the safeguard criterion for the first slice has been satisfied; and in response to the determination that the safeguard criterion for the first slice has been satisfied, selecting the final threshold value to be the candidate threshold value.

In some instances, the tradeoff logic operations can include: increasing the first risk tolerance value by a step value to obtain a second risk tolerance value; calculating, using the candidate machine-learned model and the candidate threshold value, a second performance value associated with the second risk tolerance value; determining, based on the second performance value, that the safeguard criterion for the first slice has not been satisfied; and determining that the second risk tolerance value is at an upper bound limit; and in response to the determination that the safeguard criterion for the first slice has not been satisfied and the second risk tolerance value is at the upper bound limit, selecting the final threshold value to be a fallback threshold value.

In some instances, the tradeoff logic operations can include: calculating, using a baseline machine-learned model and the candidate threshold value, a baseline performance value associated with the first risk tolerance value, the baseline machine-learned model being currently utilized by a mapping application to determine whether the input data is authentic; and selecting the final threshold value to be the final threshold value when the first performance value is greater than the baseline performance value. In some instances, the final threshold value can be the candidate threshold value when the first performance value is greater than the baseline performance value by at least a certain percentage (e.g., 5%, 10%).

In some instances, the tradeoff logic operations can include: calculating, using a production machine-learned model and the candidate threshold value, a production performance value associated with the first risk tolerance value, the production machine-learned model being currently utilized by a mapping application to determine whether the input data is authentic; and selecting the final threshold value to be a fallback threshold value when the first performance value is less than the production performance value.

At 610, the computing system can determine, using the candidate machine-learned model, whether input data is authentic based on the final threshold value.

According to some embodiments, method 600 performed by the computer system can further include receiving the input data. The input data can be associated with an update to an object in a mapping application. Method 600 can further include generating signals based on the input data. Additionally, method 600 can include inputting the signals into the candidate machine-learned model to generate a probability score and determining that the input data is authentic when the probability score exceeds the candidate threshold value. Furthermore, method 600 can include updating a map database associated with the mapping application based on the input data when the input data is determined to be authentic. Subsequently, method 600 can include publishing, based on the probability score and the final threshold value, the input data on the mapping application.

According to some embodiments, method 600 performed by the computer system can further include determining, based on the final threshold value, a second candidate threshold value for a second slice in a plurality of data slices. Additionally, method 600 can include transmitting the input data for human review based on the second candidate threshold value. Moreover, in some instances, method 600 can further include determining, based on the final threshold value and the second candidate threshold value, a third candidate threshold value for a third slice in a plurality of data slices; and determining, using the candidate machine-learned model, to not publish the input data based on the third candidate threshold value. Furthermore, in some instances, method 600 can further include determining, based on the final threshold value, the second candidate threshold value, and the third candidate threshold value, a fourth candidate threshold value for a fourth slice in a plurality of data slices; and determining, using the candidate machine-learned model, to ban a user associated with the input data based on the third candidate threshold value.

### Example Devices and Systems

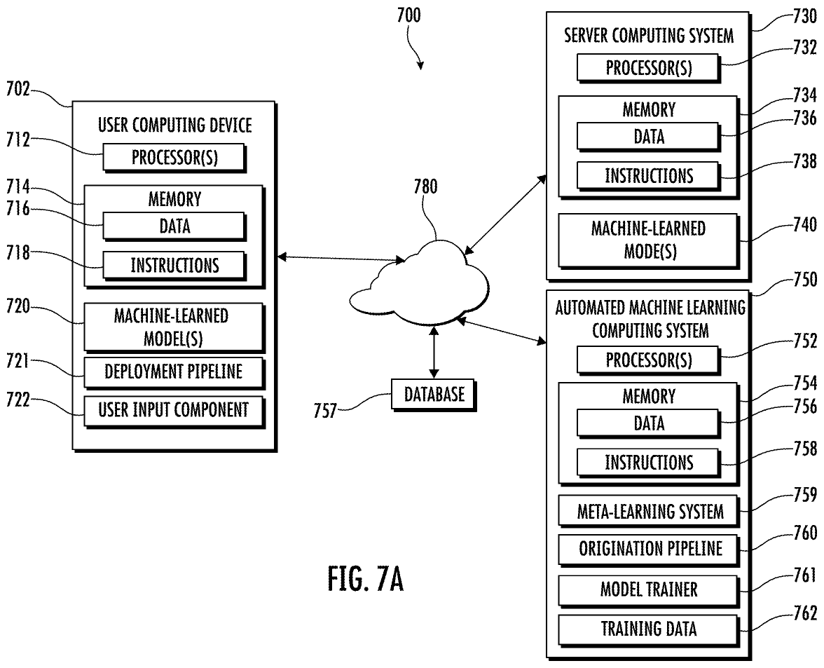

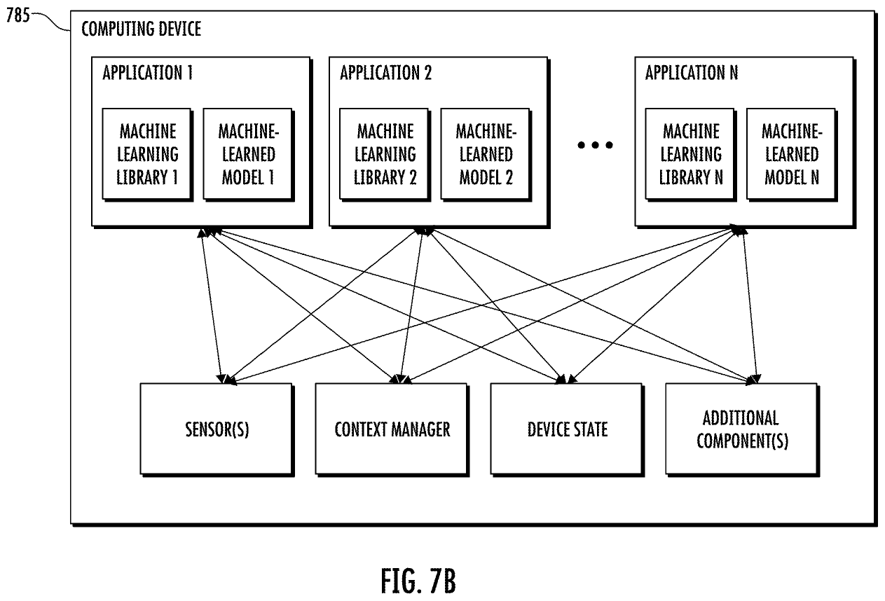

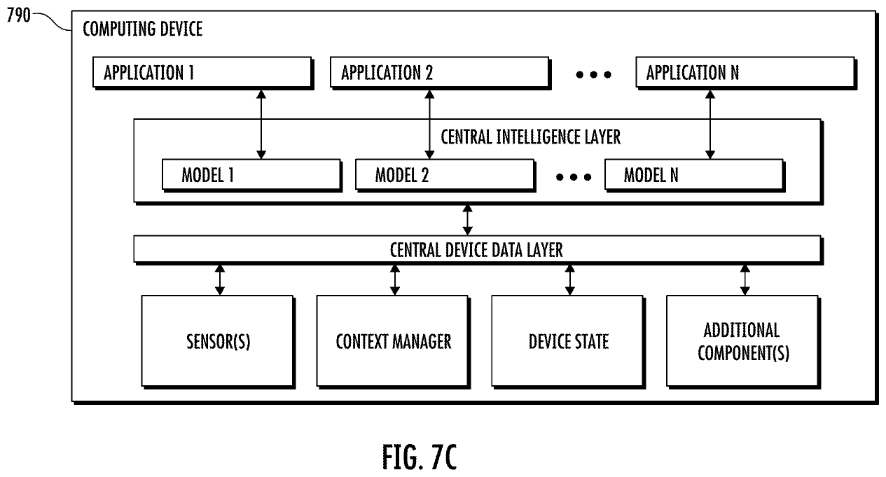

FIG. 7A depicts a block diagram of an example computing system 700 according to example implementations of the present disclosure. The system 700 includes a user computing device 702, a server computing system 730, and an automated machine learning system 750 that are communicatively coupled over a network 780.

The user computing device 702 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 702 includes one or more processors 712 and a memory 714. The one or more processors 712 can be any suitable processing device (e.g., a processor core, a microprocessor, an ASIC, an FPGA, a controller, a microcontroller, etc.) and can be one processor or a plurality of processors that are operatively connected. The memory 714 can include one or more non-transitory computer-readable storage media, such as RAM, ROM, EEPROM, EPROM, flash memory devices, magnetic disks, etc., and combinations thereof. The memory 714 can store data 716 and instructions 718 which are executed by the processor 712 to cause the user computing device 702 to perform operations.

In some implementations, the user computing device 702 can store or include one or more machine-learned models 720 and one or more deployment pipelines 721 that enable deployment of the models 720. For example, the machine-learned models 720 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 720 and corresponding origination and deployment pipelines are discussed with reference to FIGS. 1-5.

In some implementations, the one or more machine-learned models 720 can be received from the server computing system 730 over network 780, stored in the user computing device memory 714, and then used or otherwise implemented by the one or more processors 712. In some implementations, the user computing device 702 can implement multiple parallel instances of a single machine-learned model 720.

Additionally, or alternatively, one or more machine-learned models 740 can be included in or otherwise stored and implemented by the server computing system 730 that communicates with the user computing device 702 according to a client-server relationship. For example, the machine-learned models 740 can be implemented by the server computing system 740 as a portion of a web service. Thus, one or more models 720 can be stored and implemented at the user computing device 702 and/or one or more models 740 can be stored and implemented at the server computing system 730.

The user computing device 702 can also include one or more user input components 722 that receives input data. For example, the user input component 722 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 730 includes one or more processors 732 and a memory 734. The one or more processors 732 can be any suitable processing device (e.g., a processor core, a microprocessor, an ASIC, an FPGA, a controller, a microcontroller, etc.) and can be one processor or a plurality of processors that are operatively connected. The memory 734 can include one or more non-transitory computer-readable storage media, such as RAM, ROM, EEPROM, EPROM, flash memory devices, magnetic disks, etc., and combinations thereof. The memory 734 can store data 736 and instructions 738 which are executed by the processor 732 to cause the server computing system 730 to perform operations.

In some implementations, the server computing system 730 includes or is otherwise implemented by one or more server computing devices. In instances in which the server computing system 730 includes plural server computing devices, such server computing devices can operate according to sequential computing architectures, parallel computing architectures, or some combination thereof.

As described above, the server computing system 730 can store or otherwise include one or more machine-learned models 740 and one or more deployment pipelines 741 that enable deployment of the models 741. For example, the models 740 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 740 and corresponding origination and deployment pipelines are discussed with reference to FIGS. 1-5.

The user computing device 702 and/or the server computing system 730 can train the models 720 and/or 740 via interaction with the automated machine learning system 750 that is communicatively coupled over the network 780. The automated machine learning system 750 can be separate from the server computing system 730 or can be a portion of the server computing system 730.

The automated machine learning system 750 includes one or more processors 752 and a memory 754. The one or more processors 752 can be any suitable processing device (e.g., a processor core, a microprocessor, an ASIC, an FPGA, a controller, a microcontroller, etc.) and can be one processor or a plurality of processors that are operatively connected. The memory 754 can include one or more non-transitory computer-readable storage media, such as RAM, ROM, EEPROM, EPROM, flash memory devices, magnetic disks, etc., and combinations thereof. The memory 754 can store data 756 and instructions 758 which are executed by the processor 752 to cause the automated machine learning system 750 to perform operations. In some implementations, the automated machine learning system 750 includes or is otherwise implemented by one or more server computing devices.

The automated machine learning system 750 can be in communication with a database 757 that contains datasets associated with a number of different tasks and/or domains. The database 757 can be used to provide an improved benchmarking system. The benchmarking system can be used with the automated model and pipeline generation tools (e.g., deployment pipeline generation 324) described herein, but can also be used by any other models or systems. In particular, example model benchmarking systems provided by the present disclosure can include a large number (e.g., hundreds, thousands, etc.) of different datasets (e.g., training datasets, validation datasets, etc.) and associated metadata that correspond to a number of different machine-learning tasks (e.g., classification tasks, generative tasks, vision tasks, etc.) or domains (e.g., imagery, text, audio, natural language, sensor data, statistical data, etc.). As examples, the metadata associated with each dataset can include: (a) properties of the dataset; (b) problem statements; (c) feature engineering transformations; (d) hyperparameter search space; (e) training logs and signals; and/or (f) model quality metrics associated with each combination of hyperparameters.

These datasets can be stored in the database 757 and can be used to build a testing framework to test the quality of the automated machine learning system 750 in a rigorous and systematic way. For example, each time the automated machine learning system 750 is changed or altered, its performance can be measured against the datasets included in the database 757. For example, the performance of respective models automatically generated by the automated system can be measured against some portion (e.g., all) of the different tasks or domains. That is, a new version of an automated machine learning system 750 can be used to generate one or more new machine learning models for one or more datasets/tasks/domains included in the database 757. The performance of these models can be compared to the performance of other models generated by past versions of the system or other systems. The performance of the new models versus the previous models can be used as a proxy for measuring an improvement in or otherwise understanding the performance of the automated machine learning system 750.

In such fashion, the benchmarking tools described herein can provide for consistent and comparable performance benchmarking not only for specific models, but also for a larger system that seeks to automate aspects of the machine learning process (e.g., architecture searches, etc.). Furthermore, because the database 757 can include data for many different tasks or domains, the performance of the automated machine learning system 750 can be measured and optimized across such different tasks or domains or subsets thereof (e.g., user-defined subsets).

The automated machine learning system 750 can also include or be in communication with a meta-learning system 759. The meta-learning system 759 for automated machine learning system 750 can iteratively improve the automated machine learning system 750. More particularly, the automated machine learning system 750 can itself be considered to be meta-learning system 759 in which the automated machine learning system 750 is an “outer loop” that iteratively changes various aspects (e.g., architecture, hyperparameters, etc.) of the model training or generation process (i.e., the “inner loop” executed by model trainer 761) to optimize the model training or generation process, which in turn optimizes the final outputted model. The meta-learning system 759 described herein can be yet another “outer loop” around the automated machine learning system 750. For example, as described in the paragraphs above, a benchmarking system and database 757 can store hundreds or thousands of machine learning datasets for different tasks or domains. The meta-learning system 759 for automated machine learning system 750 can track metadata for every task such that the meta-learning system 759 can apply the principles of iterative testing, learning, and improvement on the automated machine learning system 750.

Thus, the parameters or hyperparameters (e.g., system settings such as, for example, number of training iterations) of the automated machine learning system 750 can be tuned (e.g., automatically tuned according to learning-based or black box optimization approaches) over time to continuously improve performance of the automated machine learning system and/or to enable high quality initial performance for new datasets. As one example, the meta-learning system 759 for automated machine learning system 750 can predict system settings for the automated machine learning system 750 to be applied to a new dataset based on characteristics of the new dataset. For example, statistical measures for the new dataset can be evaluated. Prior datasets that have similar statistical measures can be identified. The system settings that resulted in best performance for such prior datasets can be used as the initial settings for application of the automated machine learning system to the new dataset. For example, the system settings that resulted in best performance for such prior datasets can be averaged (e.g., a weighted average).

In a further example, the meta-learning system 759 for automated machine learning system 750 can include a machine-learned model (e.g., a neural network) that is trained to predict parameter or hyperparameter (e.g., system settings) for the automated machine learning system to be applied with respect to generation of a model for a new dataset. For example, the new dataset can be provided as input to the machine-learned model and, in one example, the machine-learned model can directly predict the hyperparameter values. In another example, the machine-learned model can generate a dataset embedding for the new dataset within an embedding space that encodes latent information about datasets. In such an example, other previous datasets that have embeddings that are similar (e.g., close in distance measure) to the embedding generated for the new dataset can be identified. The system settings that resulted in best performance for such prior datasets can be used as the initial settings for application of the automated machine learning system to the new dataset. For example, the system settings that resulted in best performance for such prior datasets can be averaged (e.g., a weighted average).

In further examples, an ensemble of neural networks can be trained on a dataset of previously trained model hyper-parameters from all “related” prior searches. For example, each neural network in the ensemble can take as input a collection of tuples (e.g., model hyper-parameters, dataset properties), and output (predicted mean, predicted standard deviation) of the objective value. For example, each network can be trained to maximize the log likelihood of the true objective values of all trained models across all prior searches. In some implementations, each neural network can be trained separately from an independently sampled random initialization. At prediction time, the predictions of the neural networks can be assembled to a single prediction. More precisely, in some examples, the ensemble distribution is a uniform mixture of Gaussian distributions, each of which is produced by a neural network. One example formula (via Bayesian model averaging) is: ensemble mean=mean of predicted means; ensemble standard deviation=mean of (predicted mean \hat{ }2+predicted standard deviation \hat{ }2)—ensemble mean \hat{ }2. The more disagreement there is among the ensemble members, the higher ensemble standard deviation will be, as desired.

The automated machine learning system 750 can include an origination pipeline 760. The origination pipeline 760 can be used to generate the models and/or deployment pipelines. The origination pipeline 760 can operate as described with reference to FIGS. 1-5.

The automated machine learning system 750 can include a model trainer 761 that trains the machine-learned models 720 and/or 740 stored at the user computing device 702 and/or the server computing system 730 using various training or learning techniques, such as, for example, backwards propagation of errors. For example, a loss function can be back propagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 761 can perform a number of generalization techniques (e.g., weight decays, dropouts, etc.) to improve the generalization capability of the models being trained.

In particular, the model trainer 761 can train the machine-learned models 720 and/or 740 based on a set of training data 762. In some implementations, if the user has provided consent, the training examples can be provided by the user computing device 702. Thus, in such implementations, the model 720 provided to the user computing device 702 can be trained by the automated machine learning system 750 on user-specific data received from the user computing device 702. In some instances, this process can be referred to as personalizing the model.

The model trainer 761 includes computer logic utilized to provide desired functionality. The model trainer 761 can be implemented in hardware, firmware, and/or software controlling a general-purpose processor. For example, in some implementations, the model trainer 761 includes program files stored on a storage device, loaded into a memory, and executed by one or more processors. In other implementations, the model trainer 761 includes one or more sets of computer-executable instructions that are stored in a tangible computer-readable storage medium such as RAM, hard disk, or optical or magnetic media.

The network 780 can be any type of communications network, such as a local area network (e.g., intranet), wide area network (e.g., Internet), or some combination thereof and can include any number of wired or wireless links. In general, communication over the network 780 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data).

In some cases, the input includes visual data, and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 7A illustrates one example computing system that can be used to implement the present disclosure. Other computing systems can be used as well. For example, in some implementations, the user computing device 702 can include the model trainer 761 and the training dataset 762. In such implementations, the models 720 can be both trained and used locally at the user computing device 702. In some of such implementations, the user computing device 702 can implement the model trainer 761 to personalize the models 720 based on user-specific data.

FIG. 7B depicts a block diagram of an example computing device 785 that performs according to example implementations of the present disclosure. The computing device 785 can be a user computing device or a server computing device.

The computing device 785 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 7B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 7C depicts a block diagram of an example computing device 790 that performs according to example implementations of the present disclosure. The computing device 790 can be a user computing device or a server computing device.

The computing device 790 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 7C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 790.

The central intelligence layer can communicate with a central device data layer. The central device data layer can be a centralized repository of data for the computing device 790. As illustrated in FIG. 7C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example implementations thereof, each example is provided by way of explanation, not limitation of the disclosure. Those skilled in the art, upon attaining an understanding of the foregoing, can readily produce alterations to, variations of, and equivalents to such implementations. Accordingly, the subject disclosure does not preclude inclusion of such modifications, variations and/or additions to the present subject matter as would be readily apparent to one of ordinary skill in the art. For instance, features illustrated or described as part of one implementation can be used with another implementation to yield a still further implementation. Thus, it is intended that the present disclosure covers such alterations, variations, and equivalents.

What is claimed is:

1. A computer-implemented method comprising:
obtaining a candidate threshold value for a first slice in a plurality of data slices, the candidate threshold value being utilized by a candidate machine-learned model for a discrete-valued output classification;
calculating, using the candidate machine-learned model and the candidate threshold value, a first performance value associated with a first risk tolerance value;
determining, based on the first performance value, that a safeguard criterion for the first slice has not been satisfied;
in response to the determination that the safeguard criterion for the first slice has not been satisfied, performing tradeoff logic operations to determine a final threshold value; and
determining, using the candidate machine-learned model, whether input data is authentic based on the final threshold value.

2. The method of claim 1, further comprising:
receiving the input data, the input data being associated with an update to an object in a mapping application;
generating signals based on the input data;
inputting the signals into the candidate machine-learned model to generate a probability score;
determining that the input data is authentic when the probability score exceeds the candidate threshold value; and
updating a map database associated with the mapping application based on the input data when the input data is determined to be authentic.

3. The method of claim 2, further comprising:
publishing, based on the probability score and the final threshold value, the input data on the mapping application.

4. The method of claim 1, wherein the first performance value is a good pass-through rate (GPTR), and wherein the first risk tolerance value is a live abuse rate (LAR).

5. The method of claim 1, wherein the tradeoff logic operations include:
increasing the first risk tolerance value by a step value to obtain a second risk tolerance value;
calculating, using the candidate machine-learned model and the candidate threshold value, a second performance value associated with the second risk tolerance value;
determining, based on the second performance value, that the safeguard criterion for the first slice has been satisfied; and
in response to the determination that the safeguard criterion for the first slice has been satisfied, selecting the final threshold value to be the candidate threshold value.

6. The method of claim 5, wherein the first performance value increases when the first risk tolerance value increases, and wherein the second performance value is larger than the first performance value.

7. The method of claim 1, wherein the tradeoff logic operations include:
increasing the first risk tolerance value by a step value to obtain a second risk tolerance value;
calculating, using the candidate machine-learned model and the candidate threshold value, a second performance value associated with the second risk tolerance value;
determining, based on the second performance value, that the safeguard criterion for the first slice has not been satisfied;
in response to the determination that the safeguard criterion for the first slice has not been satisfied, increasing the second risk tolerance value by the step value to obtain a third risk tolerance value;
calculating, using the candidate machine-learned model and the candidate threshold value, a third performance value associated with the third risk tolerance value;
determining, based on the third performance value, that the safeguard criterion for the first slice has been satisfied; and
in response to the determination that the safeguard criterion for the first slice has been satisfied, selecting the final threshold value to be the candidate threshold value.

8. The method of claim 1, wherein the tradeoff logic operations include:
increasing the first risk tolerance value by a step value to obtain a second risk tolerance value;
calculating, using the candidate machine-learned model and the candidate threshold value, a second performance value associated with the second risk tolerance value;
determining, based on the second performance value, that the safeguard criterion for the first slice has not been satisfied; and
determining that the second risk tolerance value is at an upper bound limit; and
in response to the determination that the safeguard criterion for the first slice has not been satisfied and the second risk tolerance value is at the upper bound limit, selecting the final threshold value to be a fallback threshold value.

9. The method of claim 1, wherein the tradeoff logic operations include:
calculating, using a baseline machine-learned model and the candidate threshold value, a baseline performance value associated with the first risk tolerance value, the baseline machine-learned model being currently utilized by a mapping application to determine whether the input data is authentic; and
selecting the final threshold value to be the final threshold value when the first performance value is greater than the baseline performance value.

10. The method of claim 9, wherein the final threshold value is the candidate threshold value when the first performance value is greater than the baseline performance value by at least a certain percentage.

11. The method of claim 1, wherein the tradeoff logic operations include:
calculating, using a production machine-learned model and the candidate threshold value, a production performance value associated with the first risk tolerance value, the production machine-learned model being currently utilized by a mapping application to determine whether the input data is authentic; and
selecting the final threshold value to be a fallback threshold value when the first performance value is less than the production performance value.

12. The method of claim 1, wherein the discrete-valued output classification is a binary classification.

13. The method of claim 1, wherein the safeguard criterion for the first slice has not been satisfied when the first performance value is below a lower limit threshold associated with a performance metric.

14. The method of claim 1, further comprising:
determining, based on the final threshold value, a second candidate threshold value for a second slice in a plurality of data slices; and
transmitting the input data for human review based on the second candidate threshold value.

15. The method of claim 14, further comprising:
determining, based on the final threshold value and the second candidate threshold value, a third candidate threshold value for a third slice in a plurality of data slices; and
determining, using the candidate machine-learned model, to not publish the input data based on the third candidate threshold value.

16. The method of claim 15, further comprising:
determining, based on the final threshold value, the second candidate threshold value, and the third candidate threshold value, a fourth candidate threshold value for a fourth slice in a plurality of data slices; and
determining, using the candidate machine-learned model, to ban a user associated with the input data based on the third candidate threshold value.

17. A computing system, comprising:
one or more processors; and
one or more non-transitory computer-readable media that collectively store:
a candidate machine-learned model, wherein the machine-learned inpainting model is configured to generate a final threshold value for a first slice in a plurality of data slices; and
instructions that, when executed by the one or more processors, cause the computing system to perform operations, the operations comprising:
obtaining a candidate threshold value for the first slice, the candidate threshold value being utilized by the candidate machine-learned model for a discrete-valued output classification;
calculating, using the candidate machine-learned model and the candidate threshold value, a first performance value associated with a first risk tolerance value;
determining, based on the first performance value, that a safeguard criterion for the first slice has not been satisfied;
in response to the determination that the safeguard criterion for the first slice has not been satisfied, performing a tradeoff logic operation to determine a final threshold value for the first slice; and
determining, using the candidate machine-learned model, whether input data is authentic based on the final threshold value.

18. The computer system of claim 17, the operations further comprising:
receiving the input data, the input data being associated with an update to an object in a mapping application;
generating signals based on the input data;
inputting the signals into the candidate machine-learned model to generate a probability score;
determining that the input data is authentic when the probability score exceeds the candidate threshold value; and
updating a map database associated with the mapping application based on the input data when the input data is determined to be authentic.

19. The computer system of claim 18, the operations further comprising:
publishing, based on the probability score and the final threshold value, the input data on the mapping application.

20. One or more non-transitory computer-readable media that collectively store a candidate machine-learned model, wherein the candidate machine-learned model has been learned by performance of operations, the operations comprising:
obtaining a candidate threshold value for a first slice in a plurality of data slices, the candidate threshold value being utilized by the candidate machine-learned model for a discrete-valued output classification;
calculating, using the candidate machine-learned model and the candidate threshold value, a first performance value associated with a first risk tolerance value;
determining, based on the first performance value, that a safeguard criterion for the first slice has not been satisfied;
in response to the determination that the safeguard criterion for the first slice has not been satisfied, determining a final threshold value for the first slice, wherein determining the final threshold value comprises performing a tradeoff logic operation to determine the final threshold value; and
determining, using the candidate machine-learned model, whether input data is authentic based on the final threshold value.
